(19) United States
(12) Patent Application Publication
(10) Pub. No.: US 2005/0054389 A1
(43) Pub. Date: Mar. 10, 2005

(54) Method for a fast state transition from a sleep mode to an awake mode in a broadband wireless access communication system

(75) Inventors: Sung-Jin Lee, Suwon-si (KR); Chang-Hoi Koo, Seongnam-si (KR); Jung-Je Son, Seongnam-si (KR); Yeong-Moon Son, Anyang-si (KR); So-Hyun Kim, Suwon-si (KR); Hyun-Jeong Kang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/935,210

(22) Filed: Sep. 7, 2004

(30) Foreign Application Priority Data
Sep. 4, 2003 (KR) 61897/2003

(51) Int. Cl. H04B 1/38

(52) U.S. Cl. 455/574

(57) ABSTRACT

A method for mode transition of a subscriber station between a sleep mode and an awake mode in a broadband wireless access communication system including a base station and at least the subscriber station, the subscriber station having data to transmit in the awake mode and not having data to transmit in the sleep mode is disclosed. The method includes receiving a dedicated orthogonal code from the base station and transiting into the sleep mode in the awake mode, the dedicated orthogonal code being allocated exclusively to the subscriber station; and in the sleep mode, transmitting a message to the base station by means of the dedicated orthogonal code in order to transit into the awake mode.

### PRIORITY

This application claims priority to an application entitled “Method For Fast State Transition From Sleep Mode To Awake Mode In Broadband Wireless Access Communication System” filed in the Korean Industrial Property Office on Sep. 4, 2003 and assigned Serial No. 2003-61897, the contents of which are hereby incorporated by reference.

### BACKGROUND OF THE INVENTION

1. Field of the Invention

The present invention relates to a broadband wireless access communication system, and more particularly to a method for a fast state transition from a sleep mode to an awake mode in a broadband wireless access communication system.

2. Description of the Related Art

In a 4^{th} generation (‘4G’) communication system, which is the next generation communication system, research has been actively pursued to provide users with services having various qualities of service (‘QoS’) and supporting a transmission speed of about 100 Mbps. A current 3^{rd} generation (‘3G’) communication system supports a transmission speed of about 384 kbps in an outdoor channel environment having a relatively unfavorable channel environment, and supports a maximum transmission speed of 2 Mbps even in an indoor channel environment which is a relatively favorable channel environment.

A wireless local area network (‘LAN’) system and a wireless metropolitan area network (‘MAN’) system generally support transmission speeds of 20 to 50 Mbps. Accordingly, in a current 4G-communication system, research has been actively pursued to develop a new type of communication system for ensuring mobility and QoS in the wireless LAN and MAN systems supporting relatively high transmission speeds, and supporting a high-speed service to be provided by the 4G communication system.

Herein, since the wireless MAN system has a wide service coverage and supports a high transmission speed, it is suitable for supporting a high-speed communication service. However, the wireless MAN system does not in any way reflect the mobility of a user, i.e., a subscriber station (SS), nor does it reflect in any way a handoff according to high-speed movement of the subscriber station.

Hereinafter, a structure of a conventional IEEE (Institute of Electrical and Electronics Engineers) 802.16a communication system functioning as a wireless MAN system as described above will be descried with reference to FIG. 1. FIG. 1 is a structure diagram schematically illustrating a structure of a system employing an orthogonal frequency division multiplexing (‘OFDM’) scheme and an orthogonal frequency division multiple access (‘OFDMA’) scheme. Specifically, FIG. 1 schematically illustrates a structure of an IEEE 802.16a communication system.

The wireless MAN system is a broadband wireless access (BWA) communication system, which has a wider service area and supports a higher transmission speed than the wireless LAN system. The IEEE 802.16a communication system employs OFDM and OFDMA schemes in order to enable a physical channel of the wireless MAN system to support a broadband transmission network. That is, the IEEE 802.16a communication system is a broadband wireless access communication system employing an OFDM/OFDMA scheme. Further, the IEEE 802.16a communication system applies an OFDM/OFDMA scheme to the wireless MAN system, which allows the IEEE 802.16a communication system to transmit a physical channel signal by means of a plurality of sub-carriers, thereby enabling a high-speed data transmission.

In addition to the IEEE 802.16a communication system, an IEEE 802.16e communication system reflects mobility of a subscriber station and detailed standard proposals for the IEEE 802.16e communication system have not yet been completely prepared or defined. In other words, both the IEEE 802.16a and the IEEE 802.16e communication systems are broadband wireless access communication systems employing the OFDM/OFDMA scheme. Hereinafter, for convenience of description, the IEEE 802.16a communication system will be described as an example.

Referring to FIG. 1, the IEEE 802.16a communication system has a single cell structure and includes a base station (BS) 100 for controlling a plurality of subscriber stations 110, 120, and 130 Transmission/reception of signals between the base station 100 and the subscriber stations 110, 120, and 130 is performed according to the OFDM/OFDMA scheme.

As described above, the IEEE 802.16a communication system currently reflects only a single cell structure and only one state in which subscriber stations are fixed, without reflecting mobility of a subscriber station. Further, as described above, the IEEE 802.16e communication system is defined as reflecting mobility of a subscriber station in addition to the IEEE 802.16a communication system. Therefore, it is required that the IEEE 802.16e communication system reflects mobility of a subscriber station in a multi-cell environment.

In order to provide mobility for a subscriber station in a multi-cell environment, a change in operations of the subscriber station and the base station is required. As a result, specific standards are presently being arranged for the multi-cell and the mobility of subscriber station in the IEEE 802.16e communication system.

In a case where mobility of subscriber station is taken into consideration in the IEEE 802.16e communication system, power consumption of the subscriber station plays an important part in the entire system. Herein, for the convenience of explanation, the subscriber station with mobility is called as a ‘mobile subscriber station (MSS). Therefore, transition between a sleep mode operation and a corresponding awake mode operation has been proposed for the mobile subscriber station and the base station in order to minimize the power consumption of the mobile subscriber station.

Hereinafter, a current sleep mode operation proposed for the IEEE 802.16e communication system will be described with reference to FIG. 2. FIG. 2 is a diagram schematically illustrating a current sleep mode operation proposed for the IEEE 802.16e communication system. The sleep mode operation will now be briefly described. The sleep mode has been proposed in order to minimize the power consumption of a mobile subscriber station in an idle interval in transmission of packet data. As described above, it is unnecessary to consider the sleep mode in the IEEE 802.16a communication system, because a subscriber station is fixed and the power can be easily supplied to the mobile subscriber station. However, in a system reflecting mobility of the mobile subscriber station, it is not easy to supply power to the mobile subscriber station that is in motion and the sleep mode operation is thus of paramount necessity.

That is, in the sleep mode, the mobile subscriber station and the base station simultaneously state-transit into the sleep mode, thereby minimizing the power consumption of the mobile subscriber station during the idle interval in which the packet data is not being transmitted. In general, the packet data is transmitted in a burst when generated. Accordingly, it is unreasonable that the same operation is performed in both an interval, in which packet data is not transmitted and an interval, in which packet data is transmitted. For this reason, the sleep mode operation as described above has been proposed.

When packet data to be transmitted is generated while both the mobile subscriber station and the base station are in the sleep mode, the mobile subscriber station and the base station must simultaneously state-transit into the awake mode and transmit/receive the packet data. The sleep mode operation described above is proposed not only for the purpose of power consumption but also as a scheme for minimizing interference between channel signals. However, since traffic has a large influence on the packet data, the sleep mode operation must be y performed in consideration of the traffic characteristic and the transmission scheme characteristic of the packet data.

Referring to FIG. 2, reference numeral 211 illustrates the generation pattern of packet data, which is a plurality of ON and OFF intervals. The ON intervals are burst intervals in which packet data (i.e., traffic) is generated and the OFF intervals are idle intervals in which the traffic is not generated. The mobile subscriber station and the base station are shifted into the sleep mode and the awake mode according to the traffic generation pattern described above, so that the power consumption of the mobile subscriber station can be minimized and interference between channel signals can be prevented.

A mode change pattern 213 of the base station and the mobile subscriber station includes a plurality of awake modes and sleep modes. In the awake modes, traffic is generated and actual exchange of packet data between the mobile subscriber station and the base station is performed. In contrast, in the sleep modes, traffic is not generated and actual exchange of packet data between the mobile subscriber station and the base station is not performed.

TA power level of the mobile subscriber station is illustrated by a pattern 215. When the power level of the mobile subscriber station is K in the awake mode, the power level of the mobile subscriber station is M in the sleep mode. Herein, when the power level K of the mobile subscriber station in the awake mode is compared with the power level M of the mobile subscriber station in the sleep mode, the value of M is much smaller than the value of K. That is, since the transmission/reception of packet data is not performed in the sleep mode, not nearly as much power of the mobile subscriber station is consumed.

That is, it is preferred to set the mobile subscriber station in such a manner that, as pattern 213 illustrates, the mobile subscriber station transits into the awake mode when there is packet data to be transmitted and into the sleep mode when there is no packet data to be transmitted, thereby lowering the transmission/reception power level of the mobile subscriber station to a possible minimum level.

Hereinafter, schemes proposed in the prior art for the IEEE 802.16e communication system in order to support the sleep mode operation will be described.

First, in order to state-transit into the sleep mode, a mobile subscriber station must necessarily receive state transition consent from a base station. Further, it is required that the base station allows the mobile subscriber station to be shifted to the sleep mode simultaneously, while buffering or dropping the packet data to be transmitted.

Also, the base station must inform the mobile subscriber station of existence of packet data to be transmitted during the listening interval of the mobile subscriber station. Herein, the mobile subscriber station awakes from the sleep mode and confirms whether there exist packet data to be transmitted from the base station to the mobile subscriber station. The listening interval will be described below in more detail.

As a result of the confirmation, when there exist the packet data to be transmitted from the base station to the mobile subscriber station, the mobile subscriber station state-transits to the awake mode and receives the packet data from the base station. In contrast, when no packet data exist to be transmitted from the base station to the mobile subscriber station, the mobile subscriber station may return to the sleep mode again or maintains the awake mode.

Hereinafter, parameters necessary in supporting the sleep mode operation and the awake mode operation will be described.

1) A Sleep Interval

The sleep interval is an interval, which is requested by a mobile subscriber station and assigned by a base station according to the request of the mobile subscriber station. Also, the sleep interval represents a time interval from a state-transition of the mobile subscriber station into a sleep mode to a state-transition of the mobile subscriber station into an awake mode again. In other words, the sleep interval is defined as an interval in which the mobile subscriber station is in the sleep mode.

The mobile subscriber station may continuously stay in the sleep mode even after the sleep interval is over. Herein, the mobile subscriber station performs an exponentially increasing algorithm by means of a preset minimum window value MIN-WINDOW and a maximum window value MAX-WINDOW, thereby updating the sleep interval. That is, it is preferred that the mobile subscriber station stays in the sleep mode during the minimum window value in the first sleep interval and exponentially increases the sleep interval when no existence of data to be transmitted continues thereafter. Further, in order to prevent the sleep interval from infinitely increasing, the maximum window value may be either maintained as it is or restored to the minimum window value, when the sleep interval has reached the maximum window value.

Herein, the minimum window value is the minimum value of the sleep interval and the maximum window value is the maximum value of the sleep interval. Further, the minimum window value the maximum window value are expressed by the number of frames and assigned by the base station. Since the minimum window value and the maximum window will be described in detail below, a further description is omitted here.

2) A Listening Interval

The listening interval is an interval, which is requested by a mobile subscriber station and assigned by a base station according to the request of the mobile subscriber station. Further, the listening interval represents a time interval from a time point at which the mobile subscriber station is awaken from a sleep mode to a time point at which the mobile subscriber station synchronizes with the downlink signal of the base station enough to be capable of decoding downlink messages such as a traffic indication (TRF_IND) message. Herein, the traffic indication message is a message representing existence of traffic, i.e., packet data, to be transmitted to the mobile subscriber station. Since the traffic indication message will be described below, a further detailed description is omitted here. The mobile subscriber station determines whether to stay in the awake mode or to state-transit into the sleep mode again according to the values of the traffic indication message.

3) A Sleep Interval Update Algorithm

When the mobile subscriber station state-transits into a sleep mode, it determines a sleep interval while regarding a preset minimum window value as a minimum sleep mode interval. After the sleep interval passes, the mobile subscriber station is awaken from the sleep mode for the listening interval and confirms existence of absence of packet data to be transmitted from the base station. As a result of the confirmation, if there exist no packet data to be transmitted, the mobile subscriber station renews the sleep interval to have a value, which is twice as long as that of a previous sleep interval and continues to stay in the sleep mode.

For example, when the minimum window value is 2, the mobile subscriber station sets the sleep interval to be 2 frames and stays in the sleep mode for 2 frames. After passage of 2 frames, the subscriber station is awaken from the sleep mode and determines whether the traffic indication message has been received.

As a result of the determination, when the traffic indication message has not been received, that is, when no packet data transmitted from the base station to the mobile subscriber station exists, the mobile subscriber station sets the sleep interval to be 4 frames, which is twice as many as 2 frames, and stays in the sleep mode for 4 frames.

In This way, the sleep interval increases from the minimum window value to a maximum window value and the update algorithm of the sleep interval is the sleep interval update algorithm.

Hereinafter, messages currently defined in the IEEE 802.16e communication system in order to support the sleep mode operation and the awake mode operation as described above, will be described.

1) A Sleep Request (SLP_REQ) Message

The sleep request message is transmitted from a mobile subscriber station to a base station and is the message used when the mobile subscriber station requests a state-transition to the sleep mode. The sleep request message contains parameters, i.e., information elements (IEs), required when the mobile subscriber station operates in the sleep mode. Table 1 illustrates the format of the sleep request message.

TABLE 1

| SYNTAX | SIZE | NOTES |
|---|---|---|
| SLP-REQ_MESSAGE_FORMAT( ) { | | |
| MANAGEMENT MESSAGE TYPE = 45 | 8 bits | |
| MIN-WINDOW | 6 bits | |
| MAX-WINDOW | 10 bits | |
| LISTENING INTERVAL | 8 bits | |
| } | | |

The sleep request message is a dedicated message transmitted based on a connection ID (CID) of a mobile subscriber station and includes information elements such as ‘MANAGEMENT MESSAGE TYPE’, ‘MINIMUM WINDOW’, ‘MAXIMUM WINDOW’, and ‘LISTENING INTERVAL’.

The information elements of the sleep request message shown in Table 1 will be described hereinafter.

First, the ‘MANAGEMENT MESSAGE TYPE’ represents a type of a message being currently transmitted. For instance, when the ‘MANAGEMENT MESSAGE TYPE’ has a value of 45, it represents the sleep request message.

The ‘MINIMUM WINDOW’ value represents a requested start value for the sleep interval (measured in frames), and the ‘MAXIMUM WINDOW’ value represents a requested stop value for the sleep interval (measured in frames). That is, as described above with reference to the sleep interval update algorithm, the sleep interval may be updated within a range from the minimum window value to the maximum window value. The ‘LISTENING INTERVAL’ represents a requested listening interval (measured in frames). The ‘LISTENING INTERVAL’ is also expressed by the number of frames.

2) A Sleep Response (SLP_RSP) Message

The sleep response message is a message in response to the sleep request message. The sleep response message may be used as a message representing whether to approve or deny the state-transition into a sleep mode requested by the mobile subscriber station, or a message representing an unsolicited instruction. Herein, when the sleep response message is used as a message for the unsolicited instruction, a detailed description is omitted here and will be provided below.

The sleep response message contains information elements required when the mobile subscriber station operates in a sleep mode. Table 2 shows the format of the sleep response message.

TABLE 2

| SYNTAX | SIZE | NOTES |
|---|---|---|
| SLP-RSP_MESSAGE_FORMAT( ) { | | |
| MANAGEMENT MESSAGE TYPE = 46 | 8 bits | |
| SLEEP-APPROVED | 1 bit | 0: SLEEP-MODE |
| | | REQUEST |
| | | DENIED |
| | | 1: SLEEP-MODE |
| | | REQUEST |
| | | APPROVED |
| IF(SLEEP-APPROVED == 0) { | | |
| RESERVED | 7 bits | |
| } ELSE { | | |
| START-TIME | 7 bits | |
| MIN-WINDOW | 6 bits | |
| MAX-WINDOW | 10 bits | |
| LISTENING INTERVAL | 8 bits | |
| } | | |
| } | | |

The sleep response message also is a dedicated message transmitted based on the connection ID of a mobile subscriber station, and the sleep response message includes information elements as shown in Table 2, which will be described hereinafter.

First, the ‘MANAGEMENT MESSAGE TYPE’ is a type of a message currently being transmitted. For instance, when the ‘MANAGEMENT MESSAGE TYPE’ has a value of 46, it represents the sleep response message. Further, the value of the ‘SLEEP-APPROVED’ is expressed by one bit. Therefore, when the ‘SLEEP-APPROVED’ has a value of 0, it implies that the request for the transition into the sleep mode has been denied (SLEEP-MODE REQUEST DENIED). In contrast, when the ‘SLEEP-APPROVED’ has a value of 1, it implies that the request for the transition into the sleep mode has been approved (SLEEP-MODE REQUEST APPROVED). Further, when the ‘SLEEP-APPROVED’ has a value of 0, a reserved area of 7 bits is made available. In contrast, when the ‘SLEEP-APPROVED’ has a value of 1, a start time value, a minimum window value, a maximum window value, and a listening interval are made available.

Herein, the value of the ‘START-TIME’ is the number of frames (not including the frame in which the message has been received) until the mobile subscriber station enters a first sleep interval. Accordingly, a frame having received the sleep response message is not contained. That is, the mobile subscriber station state-transits into a sleep mode after frames corresponding to the start time value have passed from a frame directly after the frame carrying the received sleep response message.

The value of the ‘MIN-WINDOW’ represents a start value for the sleep interval (measured in frames) and the value of the ‘MAX-WINDOW’ represents a stop value for the sleep interval (measured in frames). The value of the ‘LISTENING INTERVAL’ is a value for listening interval (measured in frames).

3) A Traffic Indication (TRF_IND) Message

The traffic indication message is a message transmitted to a mobile subscriber station during the listening interval and a message representing the existence of packet data to be transmitted from a base station to the mobile subscriber station.

Table 3 shows the format of the traffic indication message.

TABLE 3

| SYNTAX | SIZE | NOTES |
|---|---|---|
| TRF-IND_MESSAGE_FORMAT( ) { | | |
| MANAGEMENT MESSAGE TYPE = 47 | 8 bits | |
| POSITIVE_INDICATION_LIST( ) { | | TRAFFIC HAS |
| | | BEEN |
| | | ADDRESSED |
| | | TO THESE SS |
| NUM-POSITIVE | 8 bits | |
| for (i=0; i< NUM-POSITIVE; i++) { | | |
| CID | 16 bits | BASIC CID OF |
| | | THE SS |
| } | | |
| } | 128 | |

The traffic indication message is a broadcasting message transmitted according to the broadcasting method, differently from the sleep request message and the sleep response message. The traffic indication message is a message representing whether packet data to be received by the mobile subscriber station awaken from the sleep mode exist during the listening interval. The mobile subscriber station decodes the broadcasted traffic indication message during the listening interval and determines whether to state-transit into an awake mode or to continuously stay in the sleep mode.

When the mobile subscriber station state-transits into the awake mode, the mobile subscriber station confirms a frame sync. As a result of the confirmation, when the frame sync does not coincide with a frame sequence number expected by the mobile subscriber station, the mobile subscriber station can request retransmission of packet data lost in the awake mode. Meanwhile, when the mobile subscriber station fails to receive the traffic indication message during the listening interval or the traffic indication message received by the mobile subscriber station does not contain a positive indication, the mobile subscriber station returns to the sleep mode. Hereinafter, the information elements of the traffic indication message shown in Table 3 will be described.

First, the ‘Management Message Type’ is a type of a message currently being transmitted. For instance, when the ‘Management Message Type’ has a value of 47, it represents the traffic indication message. Further, the ‘POSITIVE_INDICATION_LIST’ includes values of NUM-POSITIVE (the number of positive mobile subscriber stations) and CID (connection identifier) of each positive mobile subscriber station. Consequently, the ‘POSITIVE_INDICATION_LIST’ represents the number of mobile subscriber stations and the connection IDs of the mobile subscriber stations.

Hereinafter, an operation of a mobile subscriber station, which state-transits into a sleep mode according to the request of the mobile subscriber station, will be descried with reference to FIG. 3. FIG. 3 is a flowchart illustrating a state-transition process to a sleep mode of the mobile subscriber station according to the request of the mobile subscriber station, which is proposed for the IEEE 802.16e communication system. Referring to FIG. 3, when the mobile subscriber station 300 intends to state-transit into the sleep mode, in step 311 the mobile subscriber station 300 transmits a sleep request message to a base station 350. Herein, the sleep request message includes the information elements as described in Table 1. Further, the base station 350 having received the sleep request message from the mobile subscriber station 300 determines whether to approve the request for the state-transition into the sleep mode by the mobile subscriber station 300 in consideration of situations of the mobile subscriber station 300 and the base station 350. According to the result of the determination, in step 313 the base station 350 transmits a sleep response message to the mobile subscriber station 300.

Herein, the base station 350 determines whether to approve the request for the state-transition into the sleep mode by the mobile subscriber station 300 in consideration of whether packet data must be transmitted to the mobile subscriber station 300. That is, as described in Table 2, when approving the request for the state-transition into the sleep mode by the mobile subscriber station 300, the base station 350 sets the ‘SLEEP-APPROVED’ to 1. In contrast, when denying the request for the state-transition to the sleep mode by the mobile subscriber station 300, the base station 350 sets the ‘SLEEP-APPROVED’ to 0. The information elements contained in the sleep response message are the same as in the description on Table 2.

Next, the mobile subscriber station 300 having received the sleep response message from the base station 350 confirms the value of the ‘SLEEP-APPROVED’. As a result of the confirmation, when the request for the state-transition to the sleep mode has been approved, the mobile subscriber station 300 state-transits into the sleep mode in step 315. In contrast, when the request for the state-transition to the sleep mode has been denied, the mobile subscriber station 300 stays in the current mode that is an awake mode.

Further, when the mobile subscriber station 300 state-transits into the sleep mode, the mobile subscriber station 300 reads corresponding information elements from the sleep response message and performs a sleep mode operation. Hereinafter, an operation of a mobile subscriber station, which state-transits into a sleep mode according to the control of a base station will be descried with reference to FIG. 4. FIG. 4 is a flowchart illustrating a state-transition process to a sleep mode of the mobile subscriber station according to the control of the base station, which is proposed by the IEEE 802.16e communication system. The IEEE 802.16e communication system has also proposed a scheme for using the sleep response message as a message representing an unsolicited instruction. Herein, the unsolicited instruction signifies that the mobile subscriber station operates according to the instruction (i.e., control) of the base station even without a separate request by the mobile subscriber station. FIG. 4 illustrates a situation in which the mobile subscriber station state-transits into the sleep mode according to the unsolicited instruction.

First, the base station 450 transmits the sleep response message to the mobile subscriber station 400 in step 411. Herein, the sleep response message includes the same information elements as described in Table 2. The mobile subscriber station 400 having received the sleep response message from the base station 450 confirms the value of the ‘SLEEP-APPROVED’ contained in the sleep response message. As a result of the confirmation, when the request for the state-transition to the sleep mode has been approved, the mobile subscriber station 400 state-transits into the sleep mode in step 413.

In FIG. 4, since the sleep response message is used as an unsolicited instruction message, the value of the ‘SLEEP-APPROVED’ is expressed only as ‘1’. Further, when the mobile subscriber station 400 state-transits into the sleep mode, the mobile subscriber station 400 reads corresponding information elements from the sleep response message and performs the sleep mode operation.

Hereinafter, an operation by which the mobile subscriber station state-transits into an awake mode according to the control of the base station will be descried with reference to FIG. 5. FIG. 5 is a flowchart illustrating a state-transition process of the mobile subscriber station into an awake mode according to the control of the base station, which is proposed by the IEEE 802.16e communication system. Referring to FIG. 5, first, when traffic to be transmitted to the mobile subscriber station 500 is generated, that is, when packet data are generated, the base station 550 transmits a traffic indication message to the mobile subscriber station 500 in step 511. Herein, the traffic indication message includes the information elements as described in Table 3.

Then, the mobile subscriber station 500 having received the traffic indication message from the base station 550 inspects whether the traffic indication message contains a positive indication. As a result of the inspection, when the traffic indication message contains a positive indication, the mobile subscriber station 500 reads a connection ID contained in the traffic indication message and inspects whether the mobile subscriber station's own connection ID is contained in the traffic indication message.

As a result of the inspection, when the connection ID of the mobile subscriber station 500 is contained in the traffic indication message, the mobile subscriber station 500 transmits a traffic confirmation (TRF_CFN) message to the base station 550 in steps 513 and 515, thereby reporting the mobile subscriber station's transition from the sleep mode to the awake mode or transmitting bandwidth request message for uplink traffic transmission, and state-transits from the sleep mode into the awake mode in step 517.

Meanwhile, the traffic confirmation message transmitted to the base station 550 by the mobile subscriber station 500 is a contention-based access message, which can be simultaneously transmitted by a plurality of mobile subscriber stations 500 within a predetermined transmissible time period as described above. Therefore, as shown by step 513, the traffic confirmation message may come into conflict with messages transmitted by other mobile subscriber stations, causing normal transmission of the traffic confirmation message to be impossible. In this case, after a predetermined back-off window time period has passed, the mobile subscriber station 500 retransmits the traffic confirmation message in step 515. Further, the traffic confirmation message continuously comes into conflict with other messages for the same reason, such a retransmission of the traffic confirmation message as described above is repeated.

The above description relates to the sleep mode operation having been proposed for the IEEE 802.16e communication system up to now, and problems in transition from the sleep mode to the awake mode will be described hereinafter. In the IEEE 802.16e communication system as described above, a mobile subscriber station transmits a traffic confirmation message or bandwidth request message to a base station in order to mode-transit from the sleep mode into the awake mode. In this case, in step 513 the traffic confirmation message or bandwidth request message can reach the base station through a channel of a contention-based interval (random access interval) which forces the message to compete with other base stations and may delay transmission of the message due to conflict according to a traffic state of the channel.

Meanwhile, in the case of transition from the sleep mode to the awake mode, in which packets to be transmitted are being stored in the base station or the mobile subscriber station and are waiting for transmission, it must be possible for the mobile subscriber station to immediately transit into the awake mode without delay. Further, the sleep mode has an advantage in that it can save a large amount of power consumption. However, the system is still required to provide a service of high quality and high performance in spite of such an advantage of the sleep mode.

However, if a transition from the sleep mode to the awake mode has time delay as described above, a mobile subscriber may consider the time delay as a degradation in quality of service or performance of the mobile subscriber station. Moreover, a transmission delay due to a transition from the sleep mode to the awake mode may cause the mobile subscriber to misunderstand that the provision of service is interrupted, even while the service is being provided. This may imply severe degradation in the quality of a packet transmission service. Therefore, it has been difficult to employ the sleep mode technique even though the sleep mode technique is advantageous in saving transmission power.

### SUMMARY OF THE INVENTION

Accordingly, the present invention has been made to solve the above-mentioned problems occurring in the prior art, and an object of the present invention is to provide a method of controlling a sleep mode in a broadband wireless access communication system.

It is another object of the present invention to provide a control method capable of enabling fast transition from a sleep mode to an awake mode in a broadband wireless access communication system.

It is still another object of the present invention to provide a method capable of minimizing transmission delay of packet data due to transition from a sleep mode to an awake mode in a broadband wireless access communication system.

It is still another object of the present invention to provide a method capable of enabling fast transition from a sleep mode to an awake mode in a broadband wireless access communication system, thereby preventing a subscriber from recognizing the transition as deterioration of service and enabling a base station and a subscriber station to provide high quality service.

In order to accomplish this object, there is provided a method for mode transition of a subscriber station between a sleep mode and an awake mode in a broadband wireless access communication system including a base station and at least the subscriber station, the subscriber station having data to transmit in the awake mode and having no data to transmit in the sleep mode, the method including, in the awake mode, receiving a dedicated orthogonal code from the base station and transiting into the sleep mode, the dedicated orthogonal code being allocated exclusively to the subscriber station; and in the sleep mode, transmitting a message to the base station by means of the dedicated orthogonal code in order to transit into the awake mode.

In accordance with another aspect of the present invention, there is provided a method employed in a broadband wireless access communication system including a base station and at least one subscriber station, between which data to be transmitted exist in an awake mode and no data to be transmitted exist in a sleep mode, the method for allocating a dedicated orthogonal code to the subscriber station by the base station, including allocating and transmitting the dedicated orthogonal code exclusively to the subscriber station, in order to transit into the sleep mode; receiving a signal transmitted using the dedicated orthogonal code allocated to the subscriber station, after transiting to the sleep mode; and processing the signal based on a decision that the signal is a signal mapped to the dedicated orthogonal code for the subscriber station.

In accordance with another aspect of the present invention, there is provided a method for mode transition into a sleep mode according to a request of a subscriber station in a broadband wireless access communication system including a base station and at least the subscriber station, between which data to be transmitted exist in an awake mode and no data to be transmitted exist in the sleep mode, the method including the subscriber station constructing a sleep request message when the subscriber station needs to transit into the sleep mode; transmitting the constructed sleep request message to the base station and simultaneously operating a timer for waiting reception of a sleep response message from the base station; and confirming dedicated orthogonal code information contained in the sleep response message and transiting from the awake mode to the sleep mode when the sleep response message is received from the base station while the timer operates.

In accordance with another aspect of the present invention, there is provided a method for mode transition into a sleep mode according to a request of a base station in a broadband wireless access communication system including a base station and at least the subscriber station, between which data to be transmitted exist in an awake mode and no data to be transmitted exist in the sleep mode, the method including the base station constructing a sleep request message when the base station needs to transit into the sleep mode; transmitting the constructed sleep request message to the subscriber station and simultaneously operating a timer for waiting reception of a sleep response message in response to the sleep request message of the base station; transiting from the awake mode to the sleep mode when the sleep response message is received from the subscriber station while the timer operates; and operating a timer for a dedicated orthogonal code allocated to the subscriber station after transiting into the sleep mode.

In accordance with another aspect of the present invention, there is provided a method for mode transition into an awake mode according to a request of a subscriber station in a broadband wireless access communication system including a base station and at least the subscriber station, between which data to be transmitted exist in the awake mode and no data to be transmitted exist in a sleep mode, the method including the subscriber station constructing a subscriber station traffic indication message when the subscriber station needs to transit into the awake mode due to detection of generation of packet data to be transmitted; transmitting the subscriber station traffic indication message and simultaneously operating a timer when the subscriber station can achieve fast access according to a contention-free method after constructing the subscriber station traffic indication message; transiting from the sleep mode to the awake mode and starting transmission of the packet data when the subscriber station traffic indication message is received while the timer operates.

In accordance with another aspect of the present invention, there is provided a method for mode transition into an awake mode according to a request of a base station in a broadband wireless access communication system including a base station and at least the subscriber station, between which data to be transmitted exist in the awake mode and no data to be transmitted exist in a sleep mode, the method including the base station constructing a base station traffic indication message when the base station needs to transit into the awake mode due to detection of generation of packet data to be transmitted; broadcasting the base station traffic indication message and simultaneously operating a timer for waiting for reception of a traffic confirmation message, after constructing the base station traffic indication message; transiting from the sleep mode to the awake mode and starting transmission of the packet data when the traffic confirmation message is received while the timer operates.

### BRIEF DESCRIPTION OF THE DRAWINGS

The above and other objects, features and advantages of the present invention will be more apparent from the following detailed description taken in conjunction with the accompanying drawings, in which:

FIG. 1 is a structure diagram schematically illustrating a structure of a system employing an OFDM/OFDMA scheme;

FIG. 2 is a diagram schematically illustrating a current sleep mode operation proposed for an IEEE 802.16e communication system;

FIG. 3 is a flowchart illustrating a state-transition process to a sleep mode of a mobile subscriber station according to a request of the mobile subscriber station, which is proposed for an IEEE 802.16e communication system;

FIG. 4 is a flowchart illustrating a state-transition process to a sleep mode of a mobile subscriber station according to a control of a base station, which is proposed by an IEEE 802.16e communication system;

FIG. 5 is a flowchart illustrating a state-transition process of a mobile subscriber station into an awake mode according to a control of a base station, which is proposed by an IEEE 802.16e communication system;

FIG. 6 is a structure diagram schematically illustrating a construction of a broadband wireless access communication system employing an OFDM/OFDMA scheme for carrying out a method according to the present invention;

FIG. 7 is a signal flowchart illustrating a state transition process according to a request of a mobile subscriber station in an IEEE 802.16e communication system according to an embodiment of the present invention;

FIG. 8 is a signal flowchart illustrating a state transition process according to a request of a base station in an IEEE 802.16e communication system according to an embodiment of the present invention;

FIG. 9 is a signal flowchart illustrating a process of state transition into an awake mode according to a request of a mobile subscriber station in an IEEE 802.16e communication system according to an embodiment of the present invention;

FIG. 10 is a signal flowchart illustrating a process of state transition into an awake mode according to a request of a base station in an IEEE 802.16e communication system according to an embodiment of the present invention;

FIG. 11 is a flowchart illustrating a state transition process according to a request of a mobile subscriber station according to an embodiment of the present invention;

FIG. 12 is a flowchart illustrating a state transition process according to a request of a base station according to an embodiment of the present invention;

FIG. 13 is a flowchart illustrating a state transition process into an awake mode according to a request of a mobile subscriber station according to an embodiment of the present invention; and

FIG. 14 is a flowchart illustrating a state transition process into an awake mode according to a request of a base station according to an embodiment of the present invention.

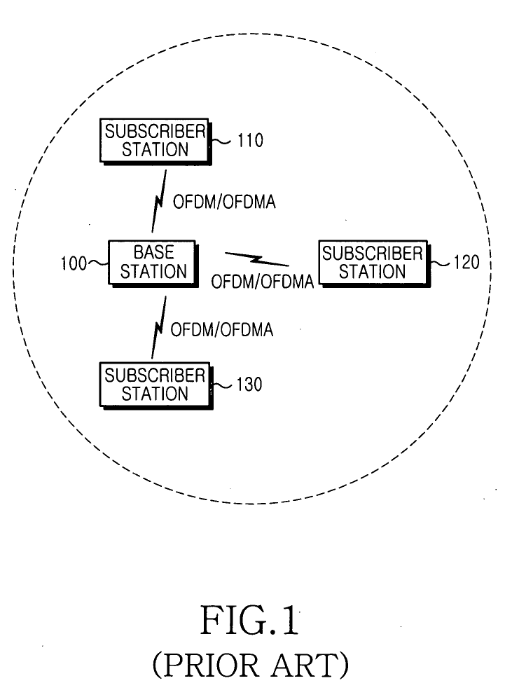

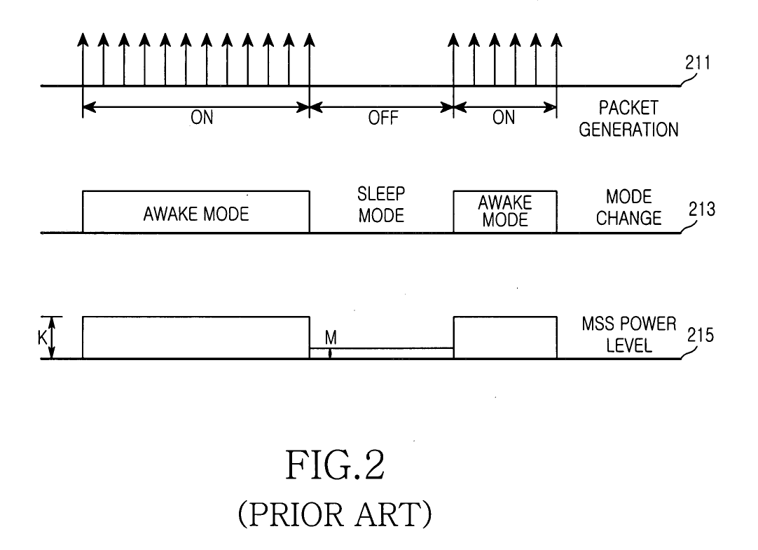

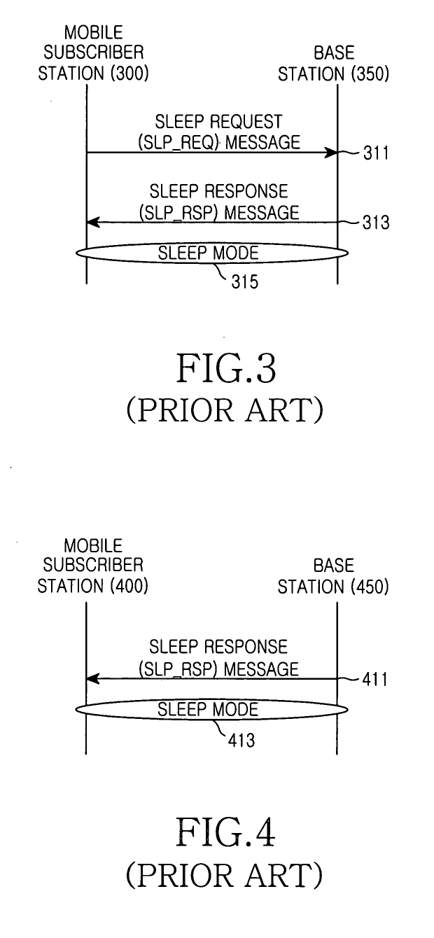

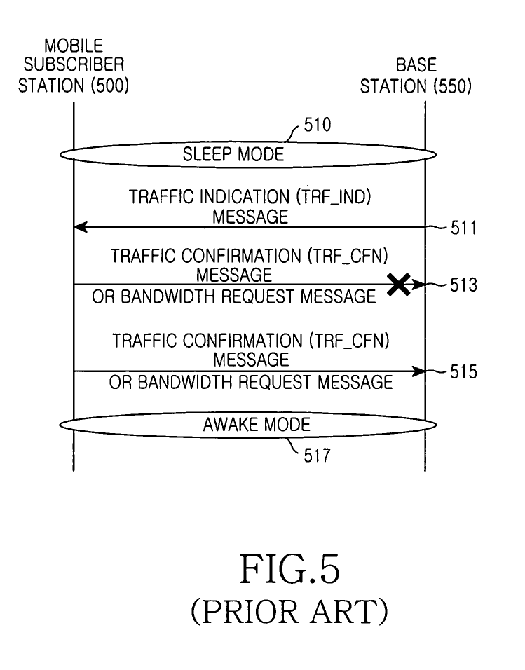

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

The present invention proposes a method capable of enabling a mobile subscriber station (MSS) and a base station (BS) to perform fast transition from a sleep mode to an awake mode in a broadband wireless access communication system employing an OFDM (Orthogonal Frequency Division Multiplexing)/OFDMA (Orthogonal Frequency Division Multiple Access) scheme. As described above, the mobile subscriber station is a subscriber station with mobility.

That is, in order to transit from a sleep mode to an awake mode, the mobile subscriber station must transmit either a traffic indication (TRF_IND) message or a traffic confirmation (TRF_CFN) message corresponding to a traffic indication message received from the base station to the base station. Herein, the traffic indication message or the traffic confirmation message is transmitted to the base station by the mobile subscriber station according to a contention-based access scheme (i.e., a random access scheme), since the transmission is carried out in the sleep mode as described above. Therefore, the traffic indication message or the traffic confirmation message may frequently conflict with other signals due to the transmission according to the contention-based access scheme, even though the traffic indication message or the traffic confirmation message must be rapidly transmitted for mode transition into the awake mode. As a result, transmission of such a message may be often delayed.

Therefore, the present invention proposes a method for enabling the traffic indication message or the traffic confirmation message sent by the mobile subscriber station to be transmitted according to a contention-free access scheme instead of the contention-based access scheme, so as to enable fast transition from the sleep mode to the awake mode.

In order to enable the traffic indication message or the traffic confirmation message to be transmitted according to a contention-free access scheme as described above, the mobile subscriber station is assigned a specific pseudorandom noise (PN) code for contention-free access of the mobile subscriber station from the base station before transition from the awake mode to the sleep mode. Herein, it is naturally possible that the mobile subscriber station is assigned a specific orthogonal code instead of the PN.

As a result, even when the mobile subscriber station is in the sleep mode, the mobile subscriber station can transmit the traffic indication message or the traffic confirmation message with the assigned specific PN code, thereby preventing the message from conflicting with other signals and enabling fast transition into the awake mode.

The specific PN code assigned to the mobile subscriber station by the base station is a finite resource controlled by the base station. Therefore, a PN code lifetime is set for the assigned PN code, so as to allow the assigned PN code to be used for a finite duration and the finite resource to be thus effectively managed.

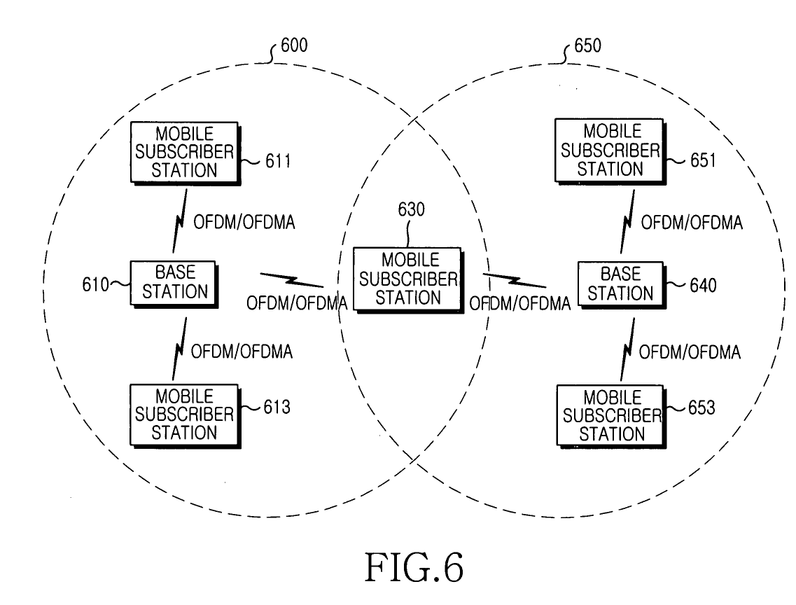

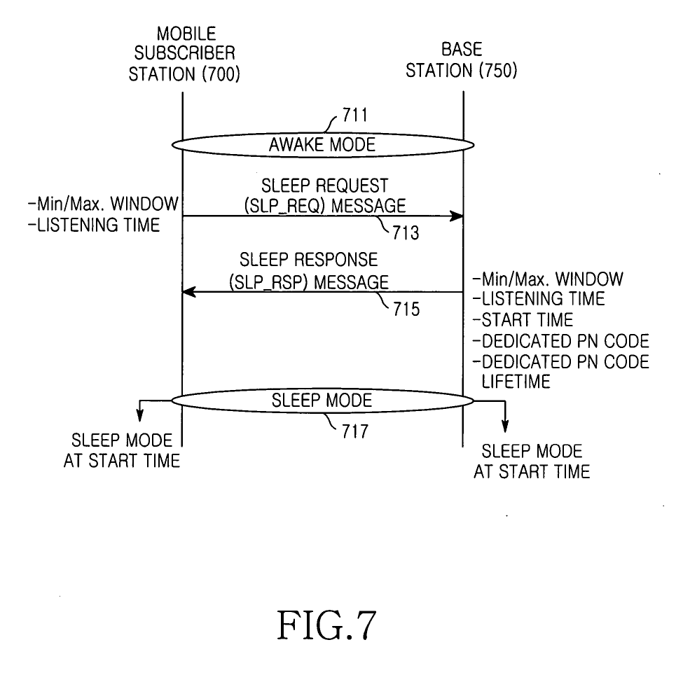

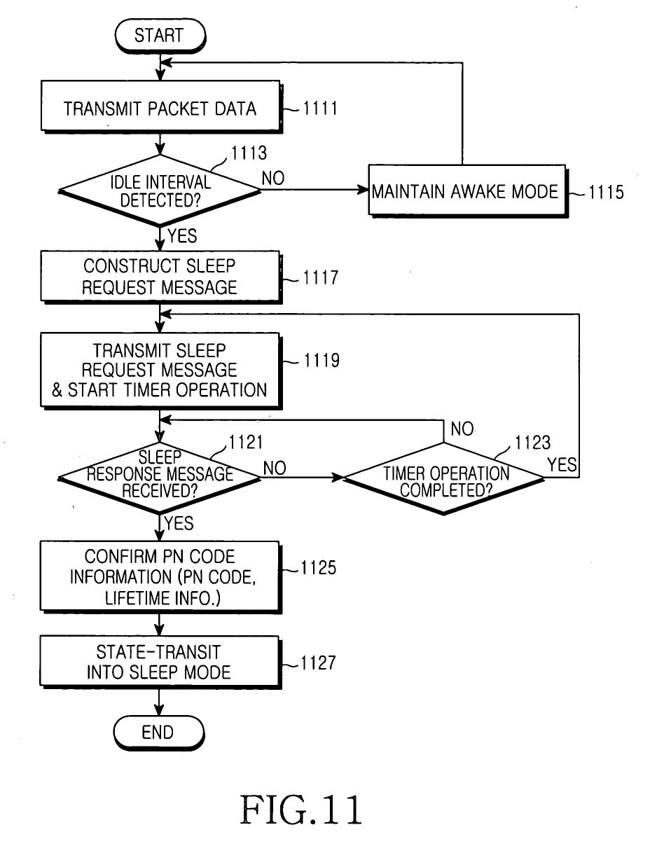

Hereinafter, in order to provide a more detailed description of the present invention, an IEEE 802.16e system reflecting the mobility of the subscriber station according to the present invention will be first described with reference to FIG. 6, and messages employable for embodiments of the present invention will be defined. As described above, the subscriber station with mobility is the mobile subscriber station. Thereafter, processes for transmitting messages in various situations according to the embodiments of the present invention will be described with reference to FIGS. 7 through 10, and operation processes according to embodiments of the present invention will be described in detail with reference to FIGS. 11 through 14.

First, a construction of a broadband wireless access communication system for implementing the present invention in a mobile environment will be described with reference to FIG. 6. FIG. 6 is a structure diagram schematically illustrating a construction of a broadband wireless access communication system employing an OFDM/OFDMA scheme for carrying out a method according to the present invention.

As described above, an IEEE 802.16e communication system is a system reflecting mobility of a subscriber station in addition to the IEEE 802.16a communication system and detailed standard proposals for the IEEE 802.16e communication system have not been completely prepared nor been completely defined yet. In order to additionally reflect mobility of a subscriber station to the IEEE 802.16a communication system, a multi-cell structure and handoff of the subscriber station, i.e. mobile subscriber station between multiple cells must be taken into consideration. The structure shown in FIG. 6 may be proposed as an IEEE 802.16e communication system for carrying out the present invention. The IEEE 802.16e communication system is a broadband wireless access communication system employing an OFDM/OFDMA scheme. In the description with reference to FIG. 6, the IEEE 802.16e communication system is employed as an example of broadband wireless access communication systems employing an OFDM/OFDMA scheme.

Referring to FIG. 6, the IEEE 802.16e communication system has a multi-cell structure, that is, has a cell 600 and a cell 650. Further, the IEEE 802.16e communication system includes a base station 610 controlling the cell 600, a base station 640 controlling the cell 650, and a plurality of mobile subscriber stations 611, 613, 630, 651, and 653. The transmission/reception of signals between the base stations 610 and 640 and the mobile subscriber stations 611, 613, 630, 651, and 653 is executed according to an OFDM/OFDMA scheme.

Herein, from among of the mobile subscriber stations 611, 613, 630, 651 and 653, the mobile subscriber station 630 is located in a cell boundary area, i.e., handoff area, between the cell 600 and the cell 650. Accordingly, only when a handoff for the mobile subscriber station 630 is supported, it is possible to support the mobility for the mobile subscriber station 630. Herein, operations for supporting handoff by the IEEE 802.16e communication system, which has not supported handoff have no relation to the present invention and thus will not be described herein.

In the IEEE 802.16e communication system in which mobility of mobile subscriber station is taken into consideration in addition to the IEEE 802.16e communication system, power consumption of the mobile subscriber station plays an important part in the entire system. Therefore, transition between a sleep mode operation and an awake mode operation corresponding to the sleep mode operation has been proposed for the mobile subscriber station and the base station in order to minimize the power consumption of the mobile subscriber station. However, the sleep mode operation and the awake mode operation having been proposed up to now for the IEEE 802.16e communication system have problems, which were described above, therefore the present invention proposes a new method for controlling the sleep mode operation, which can solve the problems.

Hereinafter, messages in relation to the sleep mode operation and the awake mode operation having been proposed up to now for the IEEE 802.16e communication system and messages for the sleep mode operation and the awake mode operation employed in the present invention will be compared with each other with reference to Table 4.

TABLE 4

| MODE | Initialization | Required message | Current method | Invention | Comments |
|---|---|---|---|---|---|
| SLEEP | MSS | SLP_REQ (MSS to BS) | ◯ | | |
| TO | Initiated | SLP_RSP (BS to MSS) | ◯ | | |
| AWAKE | BS Initiated | SLP_REQ (BS to MSS) | X | ◯ | Reuse the SLP_REQ, but IE added |
| MODE | | | | | newly (or Unsolicited Instruction |
| | | | | | of SLP_RSP) |
| | | SLP_RSP (MSS to BS) | X | ◯ | Reuse the SLP_RSP |
| AWAKE | MSS | TRF_(MSS to BS) | X | ◯ | Reuse the TRF_IND, but IE added |
| TO | Initiated | | | | newly |
| SLEEP | | TRF_CFN (BS to MSS) | X | ◯ | Newly created |
| MODE | BS Initiated | TRF_IND (BS to MSS) | ◯ | ◯ | Reuse the TRF_IND, but IE added |
| | | | | | newly |
| | | TRF_CFN (MSS to BS) | X | ◯ | Newly created |

As shown in Table 4, messages proposed for implementing the present invention include the followings.

(1) Sleep request (SLP_REQ) message requested by the base station initiated and transmitted from the base station to the mobile subscriber station

Although the IEEE 802.16e communication system has proposed only the sleep request message requested by the mobile subscriber station initiated up to now for the IEEE 802.16e communication system, a sleep request message requested by the base station is also necessary in order to implement the present invention. The sleep request message by the base station enables the base station to control mode transition of the base station into the sleep mode.

(2) Sleep response (SLP_RSP) message in response to the request of the base station (transmitted from the mobile subscriber station to the base station).

Although IEEE 802.16e has proposed only the sleep response message as a response to the sleep request message requested by the mobile subscriber station up to now for the IEEE 802.16e communication system, a sleep response message as a response to the sleep request message of the base station is also necessary in order to implement the present invention.

(3) Traffic indication (TRF_IND) message requested by the mobile subscriber station (transmitted from the mobile subscriber station to the base station).

Although IEEE 802.16e has proposed only the traffic indication message requested by the base station up to now for the IEEE 802.16e communication system, a traffic indication message requested by the mobile subscriber station is also necessary in order to implement the present invention, so that the mobile subscriber station can control the base station to transit into the awake mode.

(4) Traffic confirmation (TRF_CFN) message in response to the traffic indication message requested by the mobile subscriber station (transmitted from the base station to the mobile subscriber station).

Although IEEE 802.16e has proposed only the traffic indication message requested by the base station without proposing any confirmation message in response to the traffic indication message requested by the mobile subscriber station up to now for the IEEE 802.16e communication system. Therefore, a traffic confirmation message in response to the traffic indication message requested by the mobile subscriber station is necessary in order to implement the present invention.

(5) Traffic confirmation message in response to the traffic indication message requested by the base station (transmitted from the mobile subscriber station to the base station).

Although IEEE 802.16e has proposed only the traffic indication message requested by the base station without proposing any confirmation message in response to the traffic indication message requested by the base station up to now for the IEEE 802.16e communication system. Therefore, a traffic confirmation message in response to the traffic indication message requested by the base station is necessary in order to implement the present invention.

Hereinafter, formats of the messages, which must newly defined for the sleep mode operation and the awake mode operation according to the present invention will be described.

Sleep Request Message Requested by the Base Station

In addition to the sleep request message requested by the base station as described above, defined for the IEEE 802.16e communication system, the present invention defines new information which enables the mobile subscriber station in the sleep mode to rapidly transit back to the awake mode. Table 5 illustrates a new format for the sleep request message defined in and proposed by the present invention.

TABLE 5

| SYNTAX | SIZE | NOTES |
|---|---|---|
| SLP_REQ_MESSAGE_FORMAT( ) { | | |
| MANAGEMENT MESSAGE TYPE = 45 | 8 bits | |
| MIN-WINDOW | 6 bits | |
| MAX-WINDOW | 10 bits | |
| LISTENING INTERVAL | 8 bits | |
| START TIME | 7 bits | THIS PARAMETER EXISTS ONLY |
| | | WHEN THE MESSAGE IS SENT BY |
| | | THE BS |
| Orthogonal Code (Ranging CDMA Code) | 6 bits | |
| Code Lifetime | 8 bits | |
| } | | |

As noted from Table 5, the sleep request message is a dedicated message transmitted based on a connection ID (CID) of a mobile subscriber station, and includes information elements (IEs), such as ‘MIN-WINDOW’, ‘MAX-WINDOW’, ‘LISTENING INTERVAL’, ‘START TIME’, ‘Orthogonal Code’, and ‘Code Lifetime’.

The parameters or information elements of the sleep request message illustrated in Table 5 will be described hereinafter.

First, the ‘MANAGEMENT MESSAGE TYPE’ is a type of a message being currently transmitted. For instance, when the ‘MANAGEMENT MESSAGE TYPE’ has a value of 45, it represents the sleep request message. In the present invention, the sleep request message is a bi-directional message which always has a ‘MANAGEMENT MESSAGE TYPE’ with a value of 45 regardless of the performer of transmission of the sleep request message, which is one of the base station and the mobile subscriber station.

The ‘MIN-WINDOW’ value and the ‘MAX-WINDOW’ value are determined in different ways according to the performers of transmission of the sleep request message. First, when the performer of transmission of the sleep request message is the base station, the ‘MIN-WINDOW’ value represents a start value for the sleep interval, and the ‘MAX-WINDOW’ value represents a stop value for the sleep interval. The ‘MIN-WINDOW’ value and the ‘MAX-WINDOW’ value are measured in frames and assigned directly by the base station.

Second, when the performer of transmission of the sleep request message is the mobile subscriber station, the ‘MIN-WINDOW’ value represents a requested start value for the sleep interval (measured in frames), and the ‘MAX-WINDOW’ value represents a requested stop value for the sleep interval (measured in frames).

In other words, the minimum window value and the maximum window value represent assigned values when the base station transmits the sleep request message. In contrast, when the mobile subscriber station transmits the sleep request message, the minimum window value and the maximum window value represent values, assignment of which has been requested.

The sleep interval is an interval assigned by the base station and represents a time interval from a state-transition of the mobile subscriber station into a sleep mode to a state-transition of the mobile subscriber station into an awake mode again. In other words, the sleep interval is defined as an interval in which the mobile subscriber station stays in the sleep mode. The mobile subscriber station may continuously stay in the sleep mode even after the sleep interval. In this case, the mobile subscriber station performs an exponentially increasing algorithm by means of the minimum window value and the maximum window value, thereby updating the sleep interval.

Hereinafter, a process of updating the sleep interval will be described. The process of updating the sleep interval is performed through a sleep interval update algorithm as described above. In other words, when the base station and the mobile subscriber station mode-transit into the sleep mode, the sleep interval is determined while the preset minimum window value is considered as a minimum sleep mode interval. Thereafter, the mobile subscriber station is awaken from the sleep mode during the listening interval and confirms existence of absence of packet data to be transmitted from the base station and the mobile subscriber station. As a result of the confirmation, when there exist no packet data to be transmitted, the sleep interval is renewed to have a value, which is twice as long as that of a previous sleep interval, and the base station and the mobile subscriber station continues to stay in the sleep mode.

For instance, when the minimum window value is 2, the mobile subscriber station and the base station set the sleep interval to be 2 frames and stay in the sleep mode for 2 frames. After passage of 2 frames, the base station and the mobile subscriber station is awaken from the sleep mode and determine whether the traffic indication message has been received. As a result of the determination, when the traffic indication message has not been received, that is, when there exist no packet data transmitted to the base station nor the mobile subscriber station, the base station and the mobile subscriber station set the sleep interval to be 4 frames (twice as many as 2 frames) and stay in the sleep mode for 4 frames. In this way, the sleep interval can be increased within a range from the minimum window value to a maximum window value.

The listening interval in Table 5 is an interval assigned by the base station and represents a time interval from a time point at which the mobile subscriber station or the base station is awaken from the sleep mode to a time point at which the mobile subscriber station or the base station synchronizes with a downlink signal of the base station or an uplink signal of the mobile subscriber station enough to be capable of decoding downlink messages (i.e., traffic indication message).

Herein, as described above, the traffic indication message is a message representing existence of traffic, i.e., packet data, to be transmitted to the mobile subscriber station. The base station and the mobile subscriber station determine whether to stay in the awake mode or to state-transit again into the sleep mode according to the values of the traffic indication message.

In Table 5, the value of the ‘START TIME’ represents the number of frames (not including frames in which the message has been received) until the mobile subscriber station enters the first sleep interval. That is, the mobile subscriber station state-transits into a sleep mode after frames corresponding to the start time value have passed from a frame directly after the frame carrying the received sleep request message.

The field ‘START TIME’ is an optional information element which is not contained in the sleep request message transmitted from the mobile subscriber station to the base station but is contained only in the sleep request message transmitted from the base station to the mobile subscriber station. However, it is naturally possible to set the parameter ‘START TIME’ to be a mandatory information element which is contained in both the sleep request message transmitted from the mobile subscriber station to the base station and the sleep request message transmitted from the base station to the mobile subscriber station.

From among the elements of the sleep request message from the base station as illustrated in Table 5, the ‘Orthogonal Code’ and the ‘Code Lifetime’ are newly added fields in order to implement the present invention.

First, the field ‘Orthogonal Code’, i.e., Ranging Code Division Multiple Access (CDMA) code, is contained in and carried by the sleep request message transmitted by the base station in order to request the mobile subscriber station to transit into the sleep mode, and is an independent code dedicated only to a corresponding mobile subscriber station differently from other typical Ranging CDMA codes which are shared by multiple mobile subscriber stations.

If the sleep request message contains the field ‘Orthogonal Code’, the mobile subscriber station stores the orthogonal code when it transits into the sleep mode, and then tries access to an uplink channel using the stored orthogonal code when data to be transmitted are newly generated or it is necessary to immediately send a message to the uplink channel. In a process of trying access to an uplink channel according to the prior arts, a code used by the mobile subscriber station is randomly selected from among multiple codes shared by various other mobile subscriber stations. Therefore, the scheme of the prior art is a contention-based access scheme, and there is a possibility of conflict between messages in the trial of access. However, the dedicated orthogonal code independently allocated to the mobile subscriber station is not shared by other mobile subscriber stations but can be used only by the corresponding mobile subscriber station. Therefore, such a contention-free access scheme according to the present invention eliminates the possibility of conflict and ensures the access to the base station through the uplink channel.

Next, the field ‘Code Lifetime’ is a field defining a time period, which can be effectively used by the ‘Ranging CDMA code’. The orthogonal codes are finite resource in the number of their combinations. Therefore, when one mobile subscriber station exclusively uses the codes, available orthogonal codes may become insufficient and it may be impossible for other mobile subscriber stations to use the orthogonal codes at all. Therefore, the present invention defines a time limit in use of a corresponding code, so as to allow the corresponding mobile subscriber station to exclusively use an assigned ‘Ranging CDMA code’ only during a time period from a time point of the assignment to a time point defined in the field ‘Code Lifetime’.

In the case where the corresponding mobile subscriber station frequently mode-transits between the sleep mode and the awake mode, the corresponding mobile subscriber station can avoid using the code longer than the allowed time period and is allowed to exclusively use the code. In contrast, if the corresponding mobile subscriber station performs transition into the awake mode after passage of long time from transition into the sleep mode, the code would be exclusively used longer than the ‘code lifetime’. Therefore, in the latter case, the corresponding mobile subscriber station is not allowed to use the assigned ‘Ranging CDMA code’ longer than the allowed time period and must try the contention-based access.

Sleep Response Message Transmitted by the Base Station

When the mobile subscriber station instead of the base station has transmitted a sleep request message, the base station must transmit a sleep response message in response to the sleep request message in the IEEE 802.16e communication system. The present invention proposes a revised format for the sleep response message as shown in Table 6.

TABLE 6

| SYNTAX | SIZE | Notes |
|---|---|---|
| SLP-RSP_MESSAGE_FORMAT( ) { | | |
| MANAGEMENT MESSAGE TYPE = 46 | 8 bits | |
| SLEEP-APPROVED | 1 bit | 0: SLEEP-MODE |
| | | REQUEST DENIED |
| | | 1: SLEEP-MODE |
| | | REQUEST |
| | | APPROVED |
| IF(SLEEP-APPROVED == 0) { | | |
| RESERVED | 7 bits | |
| } ELSE { | | |
| START-TIME | 7 bits | THIS PARAMETER |
| | | EXISTS ONLY |
| | | WHEN THE |
| | | MESSAGE IS SENT |
| | | BY THE BS |
| MIN-WINDOW | 6 bits | |
| MAX-WINDOW | 10 | |
| | bits | |
| LISTENING INTERVAL | 8 bits | |
| } | | |
| Orthogonal Code (Ranging CDMA Code) | 6 bits | |
| Code Lifetime | 8 bits | |
| } | | |

The sleep response message also is a dedicated message transmitted based on a connection ID of the mobile subscriber station, and includes fields, such as ‘SPEED-APPROVED’, ‘START TIME’, ‘MIN-WINDOW’, ‘MAX-WINDOW’, ‘LISTENING INTERVAL’, ‘Orthogonal Code’, and ‘Code Lifetime’.

The information elements of the sleep response message shown in Table 6 will be described hereinafter. First, the ‘MANAGEMENT MESSAGE TYPE’ is a type of a message being currently transmitted. For instance, when the ‘MANAGEMENT MESSAGE TYPE’ has a value of 46, it represents the sleep response message. In the present invention, the sleep response message is a bi-directional message which always has a ‘MANAGEMENT MESSAGE TYPE’ with a value of 46 regardless of the performer of transmission of the sleep response message, which is one of the base station and the mobile subscriber station.

Further, the value of the ‘SLEEP-APPROVED’ is expressed as bit ‘1’. Therefore, when the ‘SLEEP-APPROVED’ has a value of 0, it implies that the request for the transition into the sleep mode has been denied (SLEEP-MODE REQUEST DENIED). In contrast, when the ‘SLEEP-APPROVED’ has a value of 1, it implies that the request for the transition into the sleep mode has been approved (SLEEP-MODE REQUEST APPROVED). Further, when the ‘SLEEP-APPROVED’ has a value of 0, reserved areas of 7 bits exist. In contrast, when the ‘SLEEP-APPROVED’ has a value of 1, a start time value, a minimum window value, a maximum window value, and a listening interval exist.

In Table 6, the value of the ‘START TIME’ represents the number of frames (not including frames in which the message has been received) until the mobile subscriber station enters the first sleep interval. That is, the mobile subscriber station state-transits into a sleep mode after frames corresponding to the start time value have passed from a frame directly after the frame carrying the received sleep request message.

The field ‘START TIME’ is an optional information element which is not contained in the sleep response message transmitted from the mobile subscriber station to the base station but is contained only in the sleep response message transmitted from the base station to the mobile subscriber station. However, it is naturally possible to set the parameter ‘START TIME’ to be a mandatory information element which is contained in both the sleep response message transmitted from the mobile subscriber station to the base station and the sleep response message transmitted from the base station to the mobile subscriber station.

As described above, only the base station can allocate the ‘START TIME’. Therefore, the ‘START TIME’ is contained only in the sleep response message transmitted from the base station to the mobile subscriber station.

Further, the ‘MIN-WINDOW’ value and the ‘MAX-WINDOW’ value are determined in different ways according to the performers of transmission of the sleep response message. First, when the performer of transmission of the sleep response message is the base station, the ‘MIN-WINDOW’and the ‘MAX-WINDOW’represent a minimum window value and a maximum window value allocated correspondingly to the required minimum window value and the required maximum window value contained in the sleep request message transmitted by the mobile subscriber station. Second, when the performer of transmission of the sleep response message is the mobile subscriber station, the ‘MIN-WINDOW’ and the ‘MAX-WINDOW’ represent the same minimum window value and the same maximum window value as the assigned minimum window value and the assigned maximum window value contained in the sleep request message transmitted by the base station.

That is, when the performer of transmission of the sleep response message is the mobile subscriber station, the minimum window value and the maximum window value contained in the sleep request message transmitted by the base station as they are become the minimum window value and the maximum window value in the sleep response message.

In the same manner, the ‘LISTENING INTERVAL’ is determined in different ways according to the performers of transmission of the sleep response message. First, when the performer of transmission of the sleep response message is the base station, the ‘LISTENING INTERVAL’ represents a listening interval allocated correspondingly to the requested listening interval contained in the sleep request message transmitted by the mobile subscriber station. Second, when the performer of transmission of the sleep response message is the mobile subscriber station, the ‘LISTENING INTERVAL’ represents the same listening interval as the listening interval contained in the sleep request message transmitted by the base station. That is, when the performer of transmission of the sleep response message is the mobile subscriber station, the listening interval contained in the sleep request message transmitted by the base station as it is becomes the listening interval in the sleep response message.

From among the elements of the sleep response message from the base station as shown in Table 6, the ‘Orthogonal Code’ and the ‘Code Lifetime’ are newly added fields according to the present invention.

The ‘Orthogonal Code’ and the ‘Code Lifetime’ have the same definitions as those in the sleep request message transmitted by the base station. However, since assignment of the codes are necessarily performed and transmitted by the base station, code information is carried by the base station-requested sleep request message BSSLP_REQ in the case of transition into the sleep mode according to the request of the base station, and is carried by the sleep response message SLP_RSP from the base station in the case of transition into the sleep mode according to the request of the mobile subscriber station.

First, the field ‘Orthogonal Code’, (i.e., Ranging CDMA code), is contained in and carried by the sleep request message transmitted by the base station in order to request the mobile subscriber station to transit into the sleep mode, and is assigned an independent code dedicated only to a corresponding mobile subscriber station differently from other typical Ranging CDMA codes which are shared by multiple mobile subscriber stations.

If the sleep response message contains the field ‘Orthogonal Code’, the mobile subscriber station stores the orthogonal code when it transits into the sleep mode, and then tries access to an uplink channel using the stored orthogonal code when data to be transmitted are newly generated or it is necessary to immediately send a message to the uplink channel.

In a process of trying access to an uplink channel according to the prior arts, a code used by the mobile subscriber station is randomly selected from among multiple codes shared by various other mobile subscriber stations. Therefore, the method of the prior art is a contention-based access method, and there is a possibility of conflict between messages in the trial of access. However, the dedicated orthogonal code independently allocated to the mobile subscriber station is not shared by other mobile subscriber stations but can be used only by the corresponding mobile subscriber station. Therefore, such a contention-free access method according to the present invention eliminates the possibility of conflict and ensures the access to the base station through the uplink channel.

Next, the field ‘Code Lifetime’ is a field defining a time period, which can be effectively used by the ‘Ranging CDMA code’. The orthogonal codes are finite resource in the number of their combinations. Therefore, when one mobile subscriber station exclusively uses the codes, available orthogonal codes may become insufficient and it may be impossible for other mobile subscriber terminals to use the orthogonal codes at all.

Therefore, the present invention defines a time limit in use of a corresponding code, so as to allow the corresponding mobile subscriber station to exclusively use an assigned ‘Ranging CDMA code’ only during a time period from a time point of the assignment to a time point defined in the field ‘Code Lifetime’. In the case where the corresponding mobile subscriber station frequently mode-transits between the sleep mode and the awake mode, the corresponding mobile subscriber station can avoid using the code longer than the allowed time period and is allowed to exclusively use the code. In contrast, if the corresponding mobile subscriber station performs transition into the awake mode after passage of long time from transition into the sleep mode, the code would be exclusively used longer than the ‘code lifetime’. Therefore, in the latter case, the corresponding mobile subscriber station is not allowed to use the assigned ‘Ranging CDMA code’ longer than the allowed time period and must try the contention-based access.

Traffic Indication Message

In the IEEE 802.16a communication system as described above, when the performer of transmission of the traffic indication message from the mobile subscriber station to the base station is the base station, the traffic information message is a broadcasting message broadcasted to a plurality of mobile subscriber stations from the base station. In contrast, when the performer of transmission of the traffic indication message is the mobile subscriber station, the traffic information message is transmitted one to one between the base station and the mobile subscriber station and does not need to be a broadcasting message.

Therefore, in the present invention, the traffic information message employs different message names and different formats according to the performers of transmission. Specifically, in the definition according to the present invention, a traffic information message transmitted from the base station to the mobile subscriber station is named a ‘base station traffic indication (BSTRF_IND) message’, and a traffic information message transmitted from the mobile subscriber station to the base station is named a ‘mobile subscriber station traffic indication (MSSTRF_IND) message’. Table 7 illustrates the base station traffic information message format.

TABLE 7

| SYNTAX | SIZE | NOTES |
|---|---|---|
| [symbol] -IND_MESSAGE_FORMAT( ) { | | |
| MANAGEMENT MESSAGE TYPE = 47 | 8 bits | |
| POSITIVE_INDICATION_LIST( ) { | | TRAFFIC HAS BEEN\| ADDRESSED |
| | | TO THESE MSS |
| [symbol] -POSITIVE | 8 bits | |
| for (i = 0; i < [symbol] -POSITIVE; i++) { | | |
| [symbol] | 16 bits | BASIC [symbol] OF THE MSS |
| PDU SEQUENCE NUMBER | 8 bits | THE PDU SEQUENCE NUMBER |
| | | WHICH HAS BEEN LASTLY |
| | | TRANSMITTED BEFORE |
| | | TRANSITION TO SLEEP MODE |
| START-TIME | 7 bits | |
| } | | |
| Orthogonal Code (Ranging CDMA Code) | 6 bits | (OPTIONAL: USED ONLY WHEN |
| | | THE BS COULDN'T ASSIGN THIS |
| | | INFORMATION IN THE [symbol] |
| | | OR [symbol] MESSAGE) |
| Code Lifetime | 8 bits | SAME AS ABOVE Orthogonal |
| | | Code Field |
| } | | |

The traffic indication message is a broadcasting message and includes fields, such as ‘NUM-POSITIVE’, ‘CID’, PDU SEQUENCE NUMBER’, ‘START TIME’, ‘Orthogonal Code’, and ‘Code Lifetime’.

The traffic indication message is a message representing whether packet data to be received by the mobile subscriber station awaken from the sleep mode exist during the listening interval. The mobile subscriber station decodes the broadcasted traffic indication message during the listening interval and determines whether to state-transit into the awake mode or to continuously stay in the sleep mode.

Hereinafter, the information elements of the traffic indication message illustrated in Table 7 will be described. First, the ‘Management Message Type’ is a type of a message currently being transmitted. For instance, when the ‘Management Message Type’ has a value of 47, it represents the traffic indication message.

Further, the ‘POSITIVE_INDICATION_LIST’ includes values of NUM-POSITIVE (the number of positive mobile subscriber stations), CID (connection ID), PDU SEQUENCE NUMBER (packet data unit sequence number), and START TIME.

Herein, the connection ID represents connection IDs of mobile subscriber stations having packet data to be transmitted from the base station, the ‘PDU SEQUENCE NUMBER’ represents the sequence number of the packet data having been lastly transmitted from the base station before transition into the sleep mode, and the ‘START TIME’ represents the number of frames (not including frames in which the message has been received) until the mobile subscriber station enters the first sleep interval.

The reason why the base station traffic indication message contains the packet data unit sequence number is as follows. When the mobile subscriber station has transited from the sleep mode to the awake mode, the subscriber station receives packet data from the base station in the awake mode. However, when packet data or the sequence number of the packet data is lost while the mobile subscriber station is in the sleep mode, the mobile subscriber station must retransmit the lost packet data to the base station.

In this case, in order to determine whether the packet data are lost, sequence reordering, etc., must be performed in a data link layer and the mobile subscriber station must request the base station to retransmit the lost packet data. As a result, the retransmission of the packet data may cause relative transmission delay and may deteriorate transmission performance of the packet data. In order to minimize deterioration of transmission performance of the packet data, it is preferred to transmit base station traffic indication message after inserting the packet data unit sequence number in the transmitted base station traffic indication message, thereby enabling the mobile subscriber station to find the lost packet data without a separate sequence reordering process.

The base station traffic indication message may employ the orthogonal code field and the code lifetime field in the same way as in the sleep request message transmitted by the base station. The two fields have the same functions as those in the sleep request message transmitted by the base station. In performing the following process for the messages proposed according to the present invention, when the base station traffic indication message includes code information, it is possible for the base station to transmit base station traffic indication message after inserting code information in the transmitted base station traffic indication message in the case where the base station has failed to allocate a code to the transmitted sleep request message from the base station or the transmitted sleep response message from the base station due to insufficiency of available codes.

First, the field ‘Orthogonal Code’, (i.e., Ranging CDMA code), is contained in and carried by the sleep request message transmitted by the base station in order to request the mobile subscriber station to transit into the sleep mode, and is assigned an independent code dedicated only to a corresponding mobile subscriber station differently from other typical Ranging CDMA codes which are shared by multiple mobile subscriber stations.

If the sleep response message includes the field ‘Orthogonal Code’, the mobile subscriber station stores the orthogonal code when it transits into the sleep mode, and then tries access to an uplink channel using the stored orthogonal code when data to be transmitted are newly generated or it is necessary to immediately send a message to the uplink channel. In a process of trying access to an uplink channel according to the prior arts, a code used by the mobile subscriber station is randomly selected from among multiple codes shared by various other mobile subscriber stations. Therefore, the scheme of the prior art is a contention-based access scheme, and there is a possibility of conflict between messages in the trial of access.

However, the dedicated orthogonal code independently allocated to the mobile subscriber station is not shared by other mobile subscriber stations but can be used only by the corresponding mobile subscriber station. Therefore, such a contention-free access scheme according to the present invention eliminates the possibility of conflict and ensures the access to the base station through the uplink channel.

Next, the field ‘Code Lifetime’ is a field defining a time period, which can be effectively used by the ‘Ranging CDMA code’. The orthogonal codes are a finite resource in the number of their combinations. Therefore, when one mobile subscriber station exclusively uses the codes, available orthogonal codes may become insufficient and it may be impossible for other mobile subscriber stations to use the orthogonal codes at all.

Therefore, the present invention defines a time limit in use of a corresponding code, so as to allow the corresponding mobile subscriber station to exclusively use an assigned ‘Ranging CDMA code’ only during a time period from a time point of the assignment to a time point defined in the field ‘Code Lifetime’. In the case where the corresponding mobile subscriber station frequently mode-transits between the sleep mode and the awake mode, the corresponding mobile subscriber station can avoid using the code longer than the allowed time period and is allowed to exclusively use the code. In contrast, if the corresponding mobile subscriber station performs transition into the awake mode after passage of long time from transition into the sleep mode, the code would be exclusively used longer than the ‘code lifetime’. Therefore, in the latter case, the corresponding mobile subscriber station is not allowed to use the assigned ‘Ranging CDMA code’ longer than the allowed time period and must try the contention-based access.

Hereinafter, a mobile subscriber station traffic information message format will be described with reference to Table 8.

TABLE 8

| SYNTAX | SIZE | NOTES |
|---|---|---|
| [symbol] -IND_MESSAGE_FORMAT( ) { | | |
| MANAGEMENT MESSAGE TYPE = 48 | 8 bits | |
| [symbol] | 16 bits | BASIC [symbol] OF THE MSS |
| PDU SEQUENCE NUMBER | 8 bits | THE PDU SEQUENCE NUMBER WHICH |
| | | HAS BEEN LASTLY TRANSMITTED |
| | | BEFORE TRANSITION TO SLEEP MODE |
| } | | |

The mobile subscriber station traffic indication message is not a broadcasting message but a dedicated message transmitted based on the CID of the mobile subscriber station. The mobile subscriber station traffic indication message includes fields, such as ‘CID’ (connection ID) and ‘PDU SEQUENCE NUMBER’ (packet data unit sequence number).

The mobile subscriber station traffic indication message is a message representing whether packet data to be received by the mobile subscriber station awaken from the sleep mode exist during the listening interval. The mobile subscriber station decodes the broadcasted traffic indication message during the listening interval and determines whether to state-transit into the awake mode or to continuously stay in the sleep mode.

Hereinafter, the information elements of the mobile subscriber station traffic indication message shown in Table 8 will be described. First, the ‘Management Message Type’ is a type of a message currently being transmitted. For instance, when the ‘Management Message Type’ has a value of 48, it represents the mobile subscriber station traffic indication message.

The connection ID represents connection IDs of mobile subscriber stations transmitting the mobile subscriber station traffic information message, and the ‘PDU SEQUENCE NUMBER’ represents the sequence number of the packet data having been lastly transmitted from the mobile subscriber station before transition into the sleep mode. The reason why the mobile subscriber station traffic indication message contains the packet data unit sequence number is the same as of the base station traffic indication message, i.e., to minimize deterioration of transmission performance of the packet data.

The mobile subscriber station traffic information message is a message reporting data generation in the mobile subscriber station, transmitted to the base station by the mobile subscriber station. According to the present invention, before the mobile subscriber station transit into the sleep mode, the mobile subscriber station may be assigned an orthogonal code transmitted to the mobile subscriber station through the sleep request message of the base station and the sleep response message transmitted from the base station for exclusive use of the mobile subscriber station, so that the mobile subscriber station can achieve fast access.

Traffic Confirmation Message

In the IEEE 802.16e communication system according to the present invention, the traffic confirmation message employs different message names and different formats according to the performers of transmission. Specifically, in the definition according to the present invention, a traffic confirmation message transmitted from the base station to the subscriber station is named a ‘base station traffic confirmation (BSTRF_CFN) message’, and a traffic confirmation message transmitted from the mobile subscriber station to the base station is named a ‘mobile subscriber station traffic confirmation (MSSTRF_CFN) message’. Table 9 illustrates the mobile subscriber station traffic confirmation message format.

TABLE 9

| SYNTAX | SIZE | NOTES |
|---|---|---|
| [symbol] _MESSAGE_FORMAT( ) { | | |
| MANAGEMENT MESSAGE TYPE = 49 | 8 bits | |
| [symbol] | 16 bits | BASIC [symbol] OF THE MSS |
| PDU SEQUENCE NUMBER | 8 bits | THE PDU SEQUENCE NUMBER WHICH |
| | | HAS BEEN LASTLY RECEIVED BEFORE |
| | | TRANSITION TO SLEEP MODE |
| } | | |

Hereinafter, the information elements of the base mobile subscriber station traffic confirmation message shown in Table 9 will be described. First, the ‘Management Message Type’ is a type of a message currently being transmitted. For instance, when the ‘Management Message Type’ has a value of 49, it represents the subscriber station traffic confirmation message.

The connection ID represents connection IDs of mobile subscriber stations transmitting the mobile subscriber station traffic confirmation message, and the ‘PDU SEQUENCE NUMBER’ represents the sequence number of the packet data having been lastly transmitted from the mobile subscriber station before transition into the sleep mode. The reason why the mobile subscriber station traffic confirmation message contains the packet data unit sequence number is the same as of the base station traffic indication message, i.e., to minimize deterioration of transmission performance of the packet data.

When the packet data unit sequence number contained in the base station traffic information message is different from the packet data unit sequence number contained in the mobile subscriber station traffic confirmation message, the base station determines the preceding one of the two PDU sequence numbers as an effective packet data unit sequence number, and restarts transmission of the packet data from the packet data corresponding to the effective packet data unit sequence number.

Further, the mobile subscriber station traffic confirmation message is a message, which can be immediately transmitted according to a contention-free uplink access scheme, i.e. fast access scheme. The fast access scheme proposed by the present invention enables the mobile subscriber station traffic confirmation message to achieve fast access to the base station through an orthogonal code (Ranging CDMA code) transmitted to the mobile subscriber station through the sleep request message of the base station and the sleep response message transmitted from the base station for exclusive use of the mobile subscriber station.

Table 10 illustrates the base station traffic confirmation message format.

TABLE 10

| SYNTAX | SIZE | NOTES |
|---|---|---|
| [symbol] _MESSAGE_FORMAT( ) { | | |
| MANAGEMENT MESSAGE TYPE = 49 | 8 bits | |
| [symbol] | 16 bits | BASIC [symbol] OF THE MSS |
| PDU SEQUENCE NUMBER | 8 bits | THE PDU SEQUENCE NUMBER WHICH |
| | | HAS BEEN LASTLY RECEIVED BEFORE |
| | | TRANSITION TO SLEEP MODE |
| START-TIME | 7 bits | |
| } | | |
| } | | |

Hereinafter, the information elements of the base station traffic confirmation message illustrated in Table 10 will be described. First, the ‘Management Message Type’ is a type a message currently being transmitted. For instance, when the ‘Management Message Type’ has a value of 49, it represents the base station traffic confirmation message. Herein, allocation of the same value to the ‘Management Message Type’ of the base station traffic confirmation message as that of the mobile subscriber station traffic confirmation message enables the mobile subscriber station traffic confirmation message to additionally include only the start time value as an optional information element. That is to say, the mobile subscriber station traffic confirmation message may be used as the base station traffic confirmation message only by adding the start time value (as an optional information element) to the mobile subscriber station traffic confirmation message, so that the traffic confirmation message may have a single type of message format.

The connection ID represents connection IDs of mobile subscriber stations receiving the base station traffic confirmation message, and the ‘PDU SEQUENCE NUMBER’ represents the sequence number of the packet data having been lastly transmitted from the mobile subscriber station before transition into the sleep mode. The reason why the base station traffic confirmation message contains the packet data unit sequence number is also the same as of the mobile subscriber station traffic indication message, i.e., to minimize deterioration of transmission performance of the packet data.

When the packet data unit sequence number contained in the mobile subscriber station traffic confirmation message is different from the packet data unit sequence number contained in the base station traffic confirmation message, the mobile subscriber station determines the preceding one of the two PDU sequence numbers as an effective packet data unit sequence number, and restarts transmission of the packet data from the packet data corresponding to the effective packet data unit sequence number.

In Table 10, the value of the ‘START TIME’ represents the number of frames (not including frames by which the base station traffic confirmation message has been received) until the mobile subscriber station enters the awake mode. That is, the mobile subscriber station state-transits into the awake mode after frames corresponding to the start time value have passed from a frame directly after the frame carrying the received base station traffic confirmation message.

The field ‘START TIME’ is an optional information element which is not contained in the mobile subscriber station traffic confirmation message transmitted from the mobile subscriber station to the base station but is contained only in the base station traffic confirmation message transmitted from the base station to the mobile subscriber station. However, it is naturally possible to set the parameter ‘START TIME’ to be a mandatory information element which is contained in both the mobile subscriber station traffic confirmation message and the base station traffic confirmation message. As described above, only the base station can allocate the ‘START TIME’. Therefore, the ‘START TIME’ is contained only in the base station traffic confirmation message transmitted from the base station to the mobile subscriber station.

Next, the traffic confirmation (TRF_CFN) message will be described with reference to Table 11. The base station traffic confirmation message as illustrated in Table 10 and the mobile subscriber station traffic confirmation message illustrated in Table 9 may be replaced by the traffic confirmation message as illustrated in Table 11. Table 11 illustrates the format of the traffic confirmation message.

TABLE 11

| SYNTAX | SIZE | NOTES |
|---|---|---|
| [symbol] _MESSAGE_FORMAT( ) { | | |
| MANAGEMENT MESSAGE TYPE = 49 | 8 bits | |
| [symbol] | 16 bits | BASIC [symbol] OF THE MSS |
| PDU SEQUENCE NUMBER | 8 bits | THE PDU SEQUENCE NUMBER WHICH |
| | | HAS BEEN LASTLY RECEIVED BEFORE |
| | | TRANSITION TO SLEEP MODE |
| START-TIME | 7 bits | THIS PARAMETER EXISTS ONLY WHEN |
| | | THE MESSAGE IS SENT BY THE BS |
| } | | |
| } | | |

As noted from Table 11, the traffic confirmation message includes the same information elements as those of the base station traffic confirmation message described with reference to Table 10, except for the start time value, which is included as an optional information element. That is, the start time value is set to be included in the traffic confirmation message when the performer of transmission of the traffic confirmation message is the base station and not to be included in the traffic confirmation message when the performer of transmission of the traffic confirmation message is the mobile subscriber station.

Hereinafter, the packet data unit sequence number will be described again. The mobile subscriber station or the base station mode-transits from the sleep mode into the awake mode and restarts transmission of packet data having been temporarily stopped. Then, a receiver of the mobile subscriber station or the base station performs acquisition of re-synch and sequence numbers of packet data units having been received before the mode transition into the sleep mode. In this case, if a packet data unit is lost during the acquisition of re-synch, transmission performance of the packet data is degraded due to the retransmission, etc. Therefore, the packet data unit sequence number is transmitted as described above. When the transmitted/received packet data unit sequence numbers are different from each other, transmission is carried out based on a packet data unit sequence number having been previously transmitted. When the receiver receives a duplicate packet data unit, the packet data unit is eliminated from a buffer.

The structures of the messages transmitted between base station and mobile subscriber station for fast transition from the sleep mode to the awake mode according to the present invention are described above in detail. Hereinafter, processes of state transition according to the present invention will be described in detail according to the types of the processes with reference to FIGS. 7 through 10.

First, a process of state transition of the mobile subscriber station and the base station from the awake mode to the sleep mode according to the request of the mobile subscriber station will be described with reference to FIG. 7. FIG. 7 is a signal flowchart illustrating a process of state transition according to the request of the mobile subscriber station in an IEEE 802.16e communication system according to an embodiment of the present invention. Referring to FIG. 7, at an initial state, a mobile subscriber station 700 and a base station 750 stay in the awake mode in step 711. When the mobile subscriber station 700 needs to transit into the sleep mode, the mobile subscriber station 700 transmits a sleep request message to the base station 750 in step 713. Here, the sleep request message includes information elements as illustrated in Table 4.

The base station 750 having received the sleep request message from the mobile subscriber station 700 determines whether to approve or deny the mode transition of the mobile subscriber station 700 into the sleep mode in consideration of situations of the mobile subscriber station 700 and the base station 750, and in step 715 transmits a sleep response message to the mobile subscriber station 700 according to the result of the determination.

In this situation, the base station 750 determines whether to approve or deny the mode transition of the mobile subscriber station 700 into the sleep mode in consideration of whether there exist packet data to be transmitted to the mobile subscriber station 700. When the base station 750 approves the mode transition, the base station 750 sets the value of the ‘SLEEP-APPROVED’ to be ‘1’. In contrast, when the base station 750 denies the mode transition, the base station 750 sets the value of the ‘SLEEP-APPROVED’ to be ‘0’. The sleep response message includes information elements as shown in Table 4. Especially, the base station 750 inserts a start time value in the sleep response message and then transmits the sleep response message, so that the base station 750 can control the state transition into the sleep mode by means of the start time value. Therefore, the mobile subscriber station 700 and the base station 750 state-transit from the awake mode into the sleep mode correspondingly to the start time value in step 717.

When the base station 750 transmits the sleep response message to the mobile subscriber station 700 in step 715, the base station 750 allocates a dedicated orthogonal code, e.g., a dedicated PN code (dedicated Ranging CDMA code), which can used only by the mobile subscriber station 700, to the mobile subscriber station 700 and in step 715 sends the sleep response message carrying the dedicated orthogonal code to the mobile subscriber station 700, thereby enabling the mobile subscriber station 700 to achieve fast access when the mobile subscriber station 700 returns to the awake mode from the sleep mode. Together with the dedicated PN code, code lifetime information indicating a valid period during which the dedicated PN code is available is also carried by the sleep response message.

When the code lifetime information is included in and carried by the transmitted sleep response message, the allocated dedicated PN code is available from the sleep mode start time assigned by the base station and only during the dedicated PN code lifetime. Therefore, after passage of the code lifetime from the sleep mode start time, the mobile subscriber station 700 cannot use the allocated dedicated PN code any longer and must access the base station through a typical contention-based access scheme.

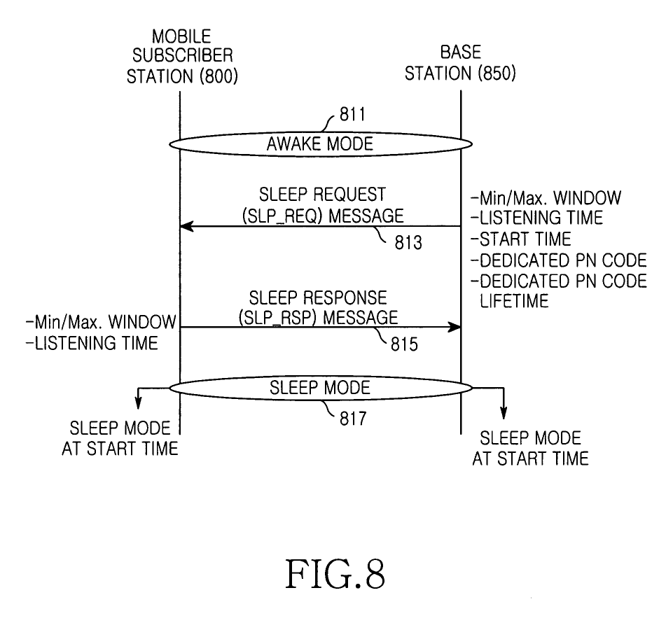

The process of state transition of the mobile subscriber station and the base station to the sleep mode in step 717 according to the request of the mobile subscriber station has been described above with reference to FIG. 7. Hereinafter, a process of state transition of the mobile subscriber station and the base station to the sleep mode according to the request of the base station will be described with reference to FIG. 8. FIG. 8 is a signal flowchart illustrating a process of state transition according to the request of the base station in an IEEE 802.16e communication system according to an embodiment of the present invention. Referring to FIG. 8, at an initial state, a mobile subscriber station 800 and a base station 850 stay in the awake mode in step 811. When the base station 850 needs to transit into the sleep mode, the base station 850 transmits a sleep request message to the mobile subscriber station 800 in step 813. Here, the sleep request message includes information elements as shown in Table 5, which include a start time value in addition to the information elements of the sleep request message described with reference to FIG. 7.

The mobile subscriber station 800 having received the sleep request message from the base station 850 determines whether to approve or deny the mode transition of the mobile subscriber station 800 into the sleep mode in consideration of situations of the mobile subscriber station 800 itself, and transmits a sleep response message to the mobile subscriber station 800 according to the result of the determination step 815. In this case, the mobile subscriber station 800 determines whether to approve or deny the mode transition of the mobile subscriber station 800 itself into the sleep mode in consideration of whether there exist packet data to be transmitted to the base station 850. When the mobile subscriber station 800 approves the mode transition, the value of the ‘SLEEP-APPROVED’ is set to be ‘1’. In contrast, when the mobile subscriber station 800 denies the mode transition, the value of the ‘SLEEP-APPROVED’ is set to be ‘0’.

The sleep response message includes information elements as illustrated in Table 6. Especially, the mobile subscriber station 800 inserts the parameters contained in the sleep request message transmitted from the base station 850, such as a minimum window value, a maximum window value, and listening interval, in the sleep response message and then transmits the sleep response message. Then, the mobile subscriber station 800 and the base station 850 state-transit from the awake mode into the sleep mode correspondingly to the start time value in step 817.

In the case illustrated in FIG. 8 also, the sleep response message transmitted from the base station 850 to the mobile subscriber station 800 includes the fields, i.e., a dedicated PN code and a code lifetime. The information of the fields is used in the same way as that described with reference to FIG. 7.

According to the processes described in detail with reference to FIGS. 7 and 8, the mobile subscriber station and the base station transit into the sleep mode, and the mobile subscriber station determines whether there is a message transmitted from the base station during only the preset listening time. In this case, the mobile subscriber station having been assigned a dedicated PN code from the base station can transmit a message to the base station using the dedicated PN code before the code lifetime passes, even though the mobile subscriber station is in the sleep mode.

In other words, in the conventional method, when the mobile subscriber station is in the sleep mode, the mobile subscriber station must transmit a message according to a contention-based scheme, (i.e., a random access scheme), so that there is always a possibility of conflict with other mobile subscriber stations. However, the PN code exclusively assigned to the mobile subscriber station by the base station according to the present invention enables the mobile subscriber station to reliably transmit a message according to a contention-free scheme even in a sleep mode.

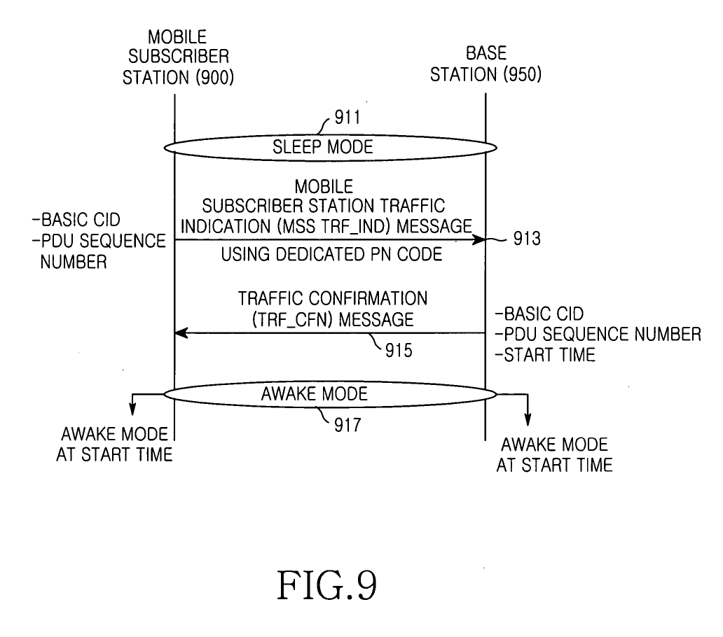

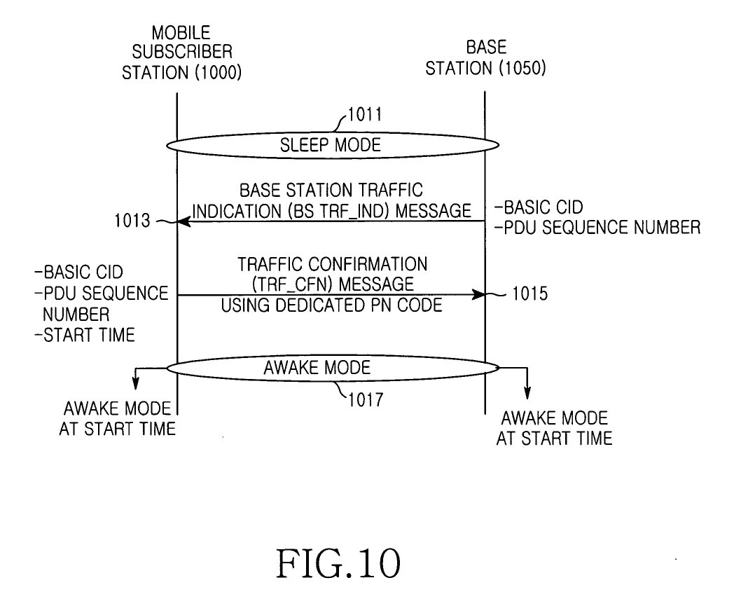

Hereinafter, a process in which a mobile subscriber station having been assigned a dedicated PN code according to the present invention transmits a message according to a contention-free scheme even in a sleep mode will be described with reference to FIGS. 9 and 10. First, a process of state transition of the subscriber station and the base station into the awake mode according to the request of the subscriber station will be described with reference to FIG. 9. FIG. 9 is a signal flowchart illustrating a process of state transition into the awake mode according to the request of the subscriber station in an IEEE 802.16e communication system according to an embodiment of the present invention.

Referring to FIG. 9, at an initial state, a mobile subscriber station 900 and a base station 950 stay in the sleep mode in step 911. When the mobile subscriber station 900 needs to transit into the awake mode, the mobile subscriber station 900 transmits a mobile subscriber station traffic information message to the base station 950 in step 913. Here, the mobile subscriber station traffic information message includes information elements as illustrated in Table 7. Especially, the mobile subscriber station traffic information message includes a sequence number of a packet data unit having been lastly transmitted before the mobile subscriber station 900 transited into the sleep mode.

The mobile subscriber station traffic information message is a message transmitted when data to be transmitted are generated in the sleep mode. Therefore, when the mobile subscriber station traffic information message is transmitted, fast transition into the awake mode is necessary. According to the present invention, the mobile subscriber station 900 can transmit the mobile subscriber station traffic information message to the base station by means of the dedicated PN code acquired through the processes described with reference to FIGS. 7 and 8 without conflict. Therefore, in the conventional method, the mobile subscriber station transmits the mobile subscriber station traffic information message according to a contention-based scheme in the sleep mode, so that the message may frequently conflict with other messages transmitted from other mobile subscriber stations, thereby delaying the transmission. However, according to the present invention, even when data to be transmitted are generated in the sleep mode, the mobile subscriber station 900 can transmit the mobile subscriber station traffic information message to the base station 950 without delay.

The base station 950 having received the mobile subscriber station traffic information message from the mobile subscriber station 900 identifies the mobile subscriber station 900 by a connection ID contained in the mobile subscriber station traffic information message, and transmits a traffic confirmation message to the mobile subscriber station 900 in step 915. Herein, the traffic confirmation message includes information elements as illustrated in Table 11. Especially, the traffic confirmation message includes a start time value. It is understood that the base station 950 may transmit a base station traffic confirmation message as illustrated in Table 10 instead of the traffic confirmation message. In the latter case, the base station traffic confirmation message includes information elements as shown in Table 10. Then, the mobile subscriber station 900 and the base station 950 transit from the sleep mode to the awake mode correspondingly to the start time value in step 917.

The process of state transition of the mobile subscriber station and the base station to the awake mode according to the request of the mobile subscriber station has been described above with reference to FIG. 9. Hereinafter, a process of state transition of the mobile subscriber station and the base station to the awake mode according to the request of the base station will be described with reference to FIG. 10. FIG. 10 is a signal flowchart illustrating a process of state transition into the awake mode according to the request of the base station in an IEEE 802.16e communication system according to an embodiment of the present invention. Referring to FIG. 10, at an initial state, in step 1011 a mobile subscriber station 1000 and a base station 1050 stay in the sleep mode in step 1011. When the base station 1050 needs to transit into the awake mode, the base station 1050 broadcasts a base station traffic information message including a connection ID of the mobile subscriber station 1000 to the base station 1050 in step 1013. Here, the base station traffic information message includes information elements as shown in Table 8. Especially, the base station traffic information message includes a sequence number of a packet data unit having been lastly transmitted before the base station 1050 transited into the sleep mode.

The subscriber station 1000 having received the base station traffic information message broadcasted by the base station 1050 reads the connection ID included in the base station traffic information message and determines whether the base station traffic information message is directed to the mobile subscriber station 1000 itself. As a result of the determination, when the base station traffic information message is a message directed to the mobile subscriber station 1000 itself, the mobile subscriber station 1000 transmits a traffic confirmation message to the base station 1050 in step 1015.

The traffic confirmation message also is a message transmitted when data to be transmitted are generated in the sleep mode and fast transition into the awake mode is necessary. Therefore, it must be guaranteed that the traffic confirmation message can be transmitted to the base station without delay for fast transition into the awake mode.

Therefore, in the process shown in FIG. 10 also, a dedicated PN code acquired through the process described with reference to FIG. 7 or 8 enables the mobile subscriber station 1000 to transmit the message to the base station 1050 without conflict, so that the subscriber station 1000 can transmit a message to the base station as soon as data are generated.

Herein, the traffic confirmation message includes information elements as shown in Table 11. The traffic confirmation message includes a start time value. It is understood that the base station 1050 may transmit a mobile subscriber station traffic confirmation message instead of the traffic confirmation message. In the latter case, the mobile subscriber station traffic confirmation message includes information elements as shown in Table 9. Then, the mobile subscriber station 1000 and the base station 1050 transit from the sleep mode to the awake mode correspondingly to the start time value in step 1017.

The processes of transmission/reception of messages between the mobile subscriber station and the base station according to the present invention have been described above with reference to FIGS. 7 through 10. Hereinafter, processes in the mobile subscriber station and the base station according to embodiments of the present invention will be described in detail with reference to FIGS. 11 through 14.

First, a process of state transition of the subscriber station and the base station into the sleep mode according to the request of the mobile subscriber station will be described with reference to FIG. 11. FIG. 11 is a flowchart illustrating a process of state transition according to the request of the mobile subscriber station according to an embodiment of the present invention. Referring to FIG. 11, the mobile subscriber station transmits packet data in the awake mode in step 1111. In step 1113, the mobile subscriber station determines whether an idle period in which packet data to be transmitted do not exist is detected during the transmission of the packet data. As a result of the determining, when an idle period is not detected, the subscriber station proceeds to step 1115, where, the subscriber station maintains the current awake mode, and then proceeds back to step 1111.

When an idle period is detected, in step 1113 the mobile subscriber station proceeds to step 1117, where it concludes from the detection of the idle period that it is necessary to transit into the sleep mode and constructs a sleep request message, and then proceeds to step 1119.

In step 1119, the mobile subscriber station transmits the constructed sleep request message to a base station to which the mobile subscriber station is connected, and simultaneously starts operation of a timer waiting for reception of a sleep response message corresponding to the sleep request message. Herein, the timer starts to be operated simultaneously when the sleep request message is transmitted, and is operated during only a time period set in advance. In step 1121, the mobile subscriber station determines whether the sleep response message is received from the base station.

As a result, when the sleep response message is not received from the base station, the mobile subscriber station proceeds to step 1123, where it examines whether the operation of the timer has been completed. As a result of the examination, when the operation of the timer has not been completed, the subscriber station proceeds back to step 1121. As a result of the examination, when the operation of the timer has been completed, the mobile subscriber station concludes that the transmitted sleep request message has failed to normally reach the base station and proceeds back to step 1119, in which the mobile subscriber station transmits the sleep request message again.

As a result of the determining in step 1121, when the sleep response message is received from the base station, the mobile subscriber station proceeds to step 1125, where it identifies dedicated PN code information contained in the received sleep response message. The dedicated PN code information includes an assigned PN code and lifetime information of the PN code.

In step 1127, the mobile subscriber station state-transits from the awake mode to the sleep mode, and then ends the process. As noted from the above process, the mobile subscriber station state-transits from the awake mode to the sleep mode, is assigned a PN code from the base station, which can be exclusively taken for a predetermined time period by the mobile subscriber station in the sleep mode, and can achieve fast state transition from the sleep mode back to the awake mode by means of the dedicated PN code.

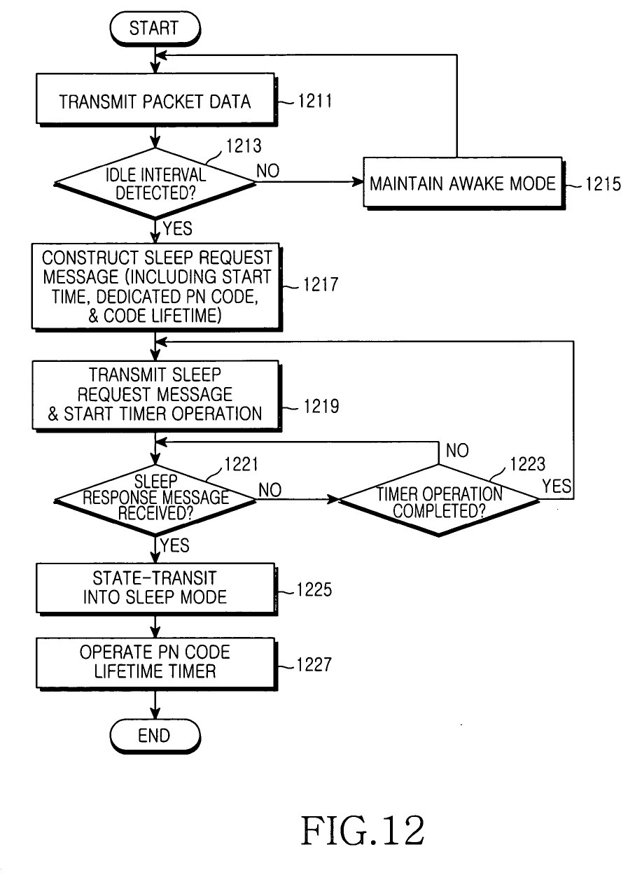

The process of state transition into the sleep mode according to the request of the mobile subscriber station has been described above with reference to FIG. 11, and a process of state transition into the sleep mode according to the request of the base station will be described hereinafter with reference to FIG. 12.

FIG. 12 is a flowchart illustrating a process of state transition according to the request of the base station according to an embodiment of the present invention. Referring to FIG. 12, first, the base station transmits packet data in the awake mode in step ¹²¹I. In step 1213, the base station determines whether an idle period in which packet data to be transmitted do not exist is detected during the transmission of the packet data. As a result of the determining, when an idle period is not detected, the base station proceeds to step 1215 where it maintains the current awake mode, and then proceeds back to step 1211.

As a result of the determining in step 1213, when an idle period is detected, the base station proceeds to step 1217. In step 1217, the base station concludes from the detection of the idle period that it is necessary to transit into the sleep mode and constructs a sleep request message. Herein, the constructed sleep request message must include information about a sleep mode start time, a dedicated PN code, and a code lifetime, which assigned by the BS according to the present invention.

The element of the start time causes the sleep request message constructed by the base station to be different from the sleep request message constructed by the base station as described with reference to FIG. 11. That is, the sleep request message constructed by the base station additionally includes the element of the start time appointing a time point at which the base station must start the state transition into the sleep mode.

After step 1217, the base station transmits in step 1219 the constructed sleep request message to a corresponding mobile subscriber station. Simultaneously, the base station starts operation of a timer waiting for reception of a sleep response message corresponding to the sleep request message. Herein, the timer starts to be operated simultaneously when the sleep request message is transmitted, and is operated during only a time period set in advance. In step 1221, the base station determines whether the sleep response message is received from the mobile subscriber station.

As a result of the determining, when the sleep response message is not received from the mobile subscriber station, the base station proceeds to step 1223. In step 1223, the base station examines whether the operation of the timer has been completed. As a result of the examination, when the operation of the timer has not been completed, the base station proceeds back to step 1221. As a result of the examination, when the operation of the timer has been completed, the base station concludes that the transmitted sleep request message has failed to normally reach the mobile subscriber station and proceeds back to step 1219, in which the base station transmits the sleep request message again.

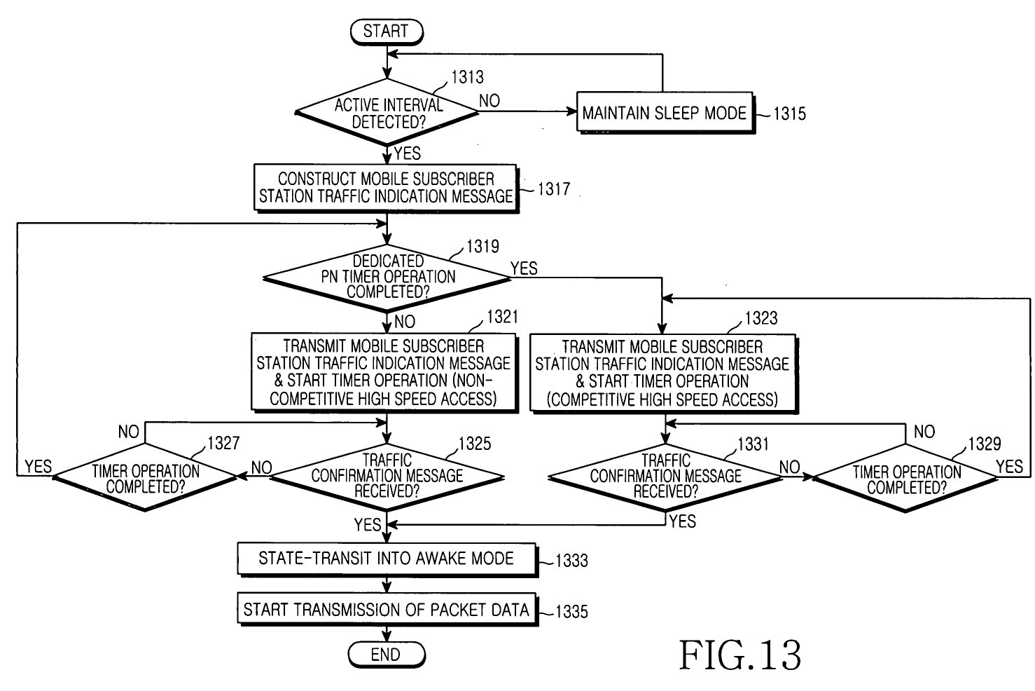

As a result of the determining in step 1221, when the sleep response message has been received from the mobile subscriber station, the base station proceeds to step 1225, where it state-transits from the awake mode to the sleep mode, and proceeds to step 1227. In step 1227, a timer for a lifetime of the dedicated PN code assigned by the base station is operated since the subscriber station started state transition into the sleep mode, and then the process is ended. The operation of the timer started in step 1227 is determined in step 1319 of FIG. 13, which will be described below, in which the mobile subscriber station tries to transit from the sleep mode to the awake mode.

In other words, when the base station state-transits from the awake mode to the sleep mode, the base station assigns a PN code to the corresponding mobile subscriber station, which can be exclusively taken during a predetermined time period by the corresponding mobile subscriber station in the sleep mode, so that the corresponding mobile subscriber station can rapidly return to the awake mode. In this case, since the base station must check the lifetime of the assigned PN code as described above, a PN code lifetime timer is operated from a time point at which the mobile subscriber station state-transits into the sleep mode.

In a conventional method, a code used by the mobile subscriber station is randomly selected from among multiple codes shared by various other mobile subscriber stations. Therefore, there is a possibility of conflict between messages in the trial of access according to the conventional scheme. However, the dedicated PN code independently allocated to the mobile subscriber station is not shared by other mobile subscriber stations but can be used only by the corresponding mobile subscriber station. Therefore, such a contention-free access scheme according to the present invention eliminates the possibility of conflict and ensures the access to the base station through the uplink channel.

The dedicated PN codes are finite resources. Therefore, when one mobile subscriber station exclusively uses the codes for an excessively long period of time, available PN codes may become insufficient. Therefore, the present invention employs operation of a timer which limits a time period during which the code can be used, and allows the corresponding mobile subscriber station to exclusively use the assigned dedicated PN code only for the lifetime of the timer.

In the case where the corresponding mobile subscriber station frequently mode-transits between the sleep mode and the awake mode, the corresponding mobile subscriber station can avoid using the code longer than the allowed time period and is allowed to exclusively use the code. In contrast, if the corresponding mobile subscriber station performs transition into the awake mode after passage of long time from transition into the sleep mode, the PN code would be exclusively used longer than the ‘code lifetime’. Therefore, in the latter case, the corresponding mobile subscriber station is not allowed to use the PN code longer than the allowed time period and must try the contention-based access.

Hereinafter, a process of state transition of the base station and mobile subscriber station into the awake mode according to the request of the mobile subscriber station will be described hereinafter with reference to FIG. 13. FIG. 13 is a flowchart illustrating a process of state transition into the awake mode according to the request of the mobile subscriber station according to an embodiment of the present invention. Referring to FIG. 13, in step 1313, the mobile subscriber station determines whether an active period is detected, that is, the subscriber station determines whether packet data to be transmitted exist.

As a result of the determining, when an active period is not detected, that is, when just one or more idle periods are detected, the mobile subscriber station proceeds to step 1315, where it maintains the current sleep mode, and then proceeds back to step 1313. As a result of the determining in step 1313, when an active period is detected, the mobile subscriber station proceeds to step 1317. In step 1317, the mobile subscriber station concludes from the detection of the active period that it is necessary to transit into the awake mode and constructs a mobile subscriber station traffic information message.

In step 1319, the subscriber station examines whether the mobile subscriber station can achieve fast access by a contention-free method according to the present invention. That is, in step 1319, the mobile subscriber station examines whether the stored lifetime of the timer for the dedicated PN code has expired. When the lifetime of the timer has expired, the mobile subscriber station proceeds to step 1323 in which the mobile subscriber station transmits the message by the conventional contention-based scheme. In contrast, when the lifetime of the timer has not expired yet, in step 1321 the mobile subscriber station transmits the mobile subscriber station traffic information message having been constructed in step 1317 to the base station through the already-assigned dedicated PN code by the contention-free fast access scheme according to the present invention.

After the mobile subscriber station transmits the message through the dedicated PN code by the contention-free fast access scheme in step 1321, the mobile subscriber station operates the timer and waits for reception of a traffic confirmation message in step 1325. In this case, when the mobile subscriber station have received no traffic confirmation message until the lifetime of the timer operated in step 1321 expires, the mobile subscriber station determines whether the lifetime of the dedicated PN code timer has expired in step 1327. As a result of the determining in step 1327, if the lifetime of the dedicated PN code timer has not expired yet, the mobile subscriber station proceeds to step 1325. In contrast, as a result of the determining in step 1327, if the lifetime of the dedicated PN code timer has expired, the mobile subscriber station proceeds back to step 1319.

When the mobile subscriber station has received a traffic confirmation message from the base station in step 1325, the mobile subscriber station proceeds to step 1333, in which the mobile subscriber station transits into the awake mode. Thereafter, the mobile subscriber station starts transmission of packet data in step 1335, and then ends the process.

Meanwhile, as a result of the examination in step 1319, when the lifetime of the timer for the dedicated PN code has expired, the mobile subscriber station proceeds to step 1323 in which the subscriber station transmits the mobile subscriber station traffic information message to the base station connected with the mobile subscriber station, and simultaneously starts operation of the timer waiting for a traffic confirmation message corresponding to the mobile subscriber station traffic information message. Herein, the timer starts to be operated as soon as the mobile subscriber station traffic information message is transmitted, and is operated during only a predetermined time period set in advance.

Then, in step 1331, the mobile subscriber station determines whether the traffic confirmation message is received from the base station. Although FIG. 13 shows the traffic confirmation message employed as an example of the response message to the mobile subscriber station traffic information message, it is understood that a base station traffic confirmation message shown in Table 10 also may be employed.

As a result of the determining in step 1331, when the traffic confirmation message has not been received from the base station, the mobile subscriber station proceeds to step 1329, where it examines whether the operation of the timer has been completed. As a result of the examination, when the operation of the timer has not yet been completed, the mobile subscriber station proceeds back to step 1331.

As a result of the examination, when the operation of the timer has been completed, the mobile subscriber station concludes that the transmitted mobile subscriber station traffic information message has failed to normally reach the base station, and proceeds back to step 1323, in which the mobile subscriber station transmits the mobile subscriber station traffic information message again.

As a result of the determining in step 1331, when the traffic confirmation message has been received from the base station, the mobile subscriber station proceeds to step 1333, where it transits from the sleep mode into the awake mode. Thereafter, the mobile subscriber station starts transmission of packet data in step 1335, and then ends the process.

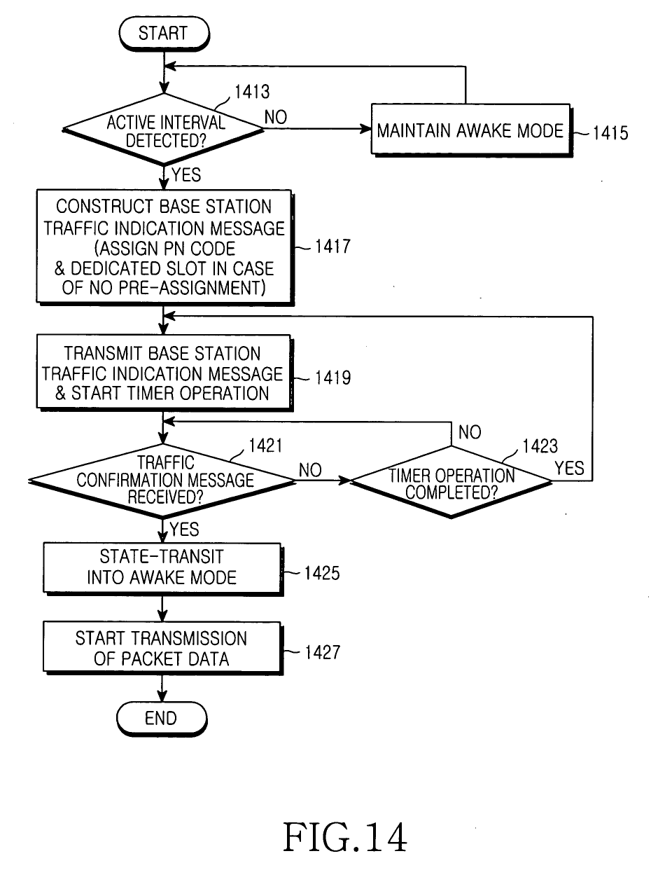

A process of state transition from the sleep mode to the awake mode according to the request of the mobile subscriber station has been described above with reference to FIG. 13. Hereinafter, a process of state transition of the base station and mobile subscriber station into the awake mode according to the request of the base station will be described with reference to FIG. 14. FIG. 14 is a flowchart illustrating a process of state transition into the awake mode according to the request of the base station according to an embodiment of the present invention. Referring to FIG. 14, in step 1413, the base station determines whether an active period is detected, that is, the base station determines whether packet data to be transmitted exist.

As a result of the determining, when an active period is not detected, that is, when only the idle period is detected, the base station proceeds to step 1415, where it maintains the current sleep mode, and then proceeds back to step 1413. As a result of the determining in step 1413, when an active period is detected, that is, when generation of packet data to be transmitted is detected, the base station proceeds to step 1417.

In step 1417, the base station concludes from the detection of the active period that it is necessary to transit into the awake mode and constructs a base station traffic information message including CIDs of corresponding mobile subscriber stations.

Herein, if the subscriber station has failed to be assigned a dedicated PN code due to insufficiency of the PN codes when the subscriber station transited into the sleep mode, the base station traffic information message employed in the process illustrated in FIG. 14 may include information of sleep mode start time, dedicated PN code, and code lifetime, assigned by the base station. The base station proceeds to step 1419 after step 1417.

In step 1419, the base station transmits the base station traffic information message through a broadcasting channel. At the same time, the base station initiates operation of the timer waiting for reception of a traffic confirmation message corresponding to the base station traffic information message and then proceeds to step 1421. Herein, the timer starts to be operated as soon as the base station traffic information message is transmitted, and is operated during only a time period set in advance. In step 1421, the base station determines whether the traffic confirmation message is received from the corresponding mobile subscriber stations. Although FIG. 14 shows the traffic confirmation message employed as an example of the response message to the base station traffic information message, is understood that a mobile subscriber station traffic confirmation message shown in Table 9 may also be employed.

As a result of the determining in step 1421, when the traffic confirmation message has not been received from the corresponding mobile subscriber stations, the base station proceeds to step 1423, where it examines whether the operation of the timer has been completed. As a result of the examination, when the operation of the timer has not been completed yet, the base station proceeds back to step 1421. As a result of the examination, when the operation of the timer has been completed, the base station concludes that the transmitted base station traffic information message has failed to normally reach the corresponding mobile subscriber stations, and proceeds back to step 1419, in which the base station transmits the base station traffic information message again.

As a result of the determining in step 1421, when the traffic confirmation message has been received from the corresponding mobile subscriber stations, the base station proceeds to step 1425, where it transits from the sleep mode into the awake mode. Thereafter, the base station starts transmission of packet data in step 1427, and then ends the process.

The present invention as described above enables a broadband wireless access communication system employing an OFDM/OFDMA scheme, i.e., an IEEE 802.16e communication system, to achieve fast transition between a sleep mode and an awake mode. Specifically, when a subscriber station transmits a message in order to transit from a sleep mode to an awake mode, the transition can be carried out instantly by means of a dedicated orthogonal code (e.g., a dedicated PN code) preliminarily allocated for use during a predetermined time period according to the present invention, as opposed to the conventional contention-based access method in which transmission delay is inevitable due to conflict between messages.

While the invention has been shown and described with reference to certain preferred embodiments thereof, it will be understood by those skilled in the art that various changes in form and details may be made therein without departing from the spirit and scope of the invention as defined by the appended claims.

1. A method for mode transition of a mobile subscriber station between a sleep mode and an awake mode in a broadband wireless access communication system including a base station and at least one mobile subscriber station, the mobile subscriber station having data for transmission in the awake mode and not having data to transmit in the sleep mode, the method comprising the steps of:
receiving request signal of transition to the sleep mode including a dedicated code from the base station in the awake mode, and transiting into the sleep mode; and
detecting need of transition to the awake mode in the sleep mode, transmitting request signal of transition to the awake mode to the base station using the dedicated code.

2. The method as claimed in claim 1, wherein the dedicated code is a dedicated PN (Psuedo-random Noise) code allocated to be exclusively used by the mobile subscriber station.

3. The method as claimed in claim 1, wherein, the request signal of the transition to the sleep mode further includes an available time period during which the dedicated code can be used.

4. The method as claimed in claim 3, wherein, when the available time period for the dedicated code has expired, the mobile subscriber station, transmits the request signal of the transition to the awake mode through a contention-based access scheme.

5. The method as claimed in claim 1, wherein the request signal of the transition to the sleep mode is contained in a sleep request message transmitted by the base station.

6. The method as claimed in claim 1, wherein the dedicated code is contained in and carried by a sleep response message transmitted by the base station in response to a sleep request message transmitted by the mobile subscriber station.

7. The method as claimed in claim 1, wherein the request signal of the transition to the awake mode transmitted by the mobile subscriber station using the dedicated code in the sleep mode is contained in a traffic indication message.

8. The method as claimed in claim 1, wherein the request signal of the transition to the awake mode transmitted by the mobile subscriber station using the dedicated code in the sleep mode is contained in a traffic confirmation message transmitted in response to a traffic indication message transmitted by the base station.

9. The method as claimed in claim 1, wherein the request signal of the transition to the awake mode transmitted by the mobile subscriber station using the dedicated code in the sleep mode is contained in a bandwidth request message.

10. The method as claimed in claim 1, wherein the request signal of the transition to the awake mode transmitted to the base station using the dedicated code is contained in a contention-free access message.

11. A method for allocating a dedicated orthogonal code to a mobile subscriber station by a base station in a broadband wireless access communication system including the base station and at least one mobile subscriber station, between which data to be transmitted exists in an awake mode and data to be transmitted does not exists in a sleep mode, the method comprising the steps of:
allocating and transmitting the dedicated orthogonal code exclusively to the mobile subscriber station, in order to transit into the sleep mode;
receiving a signal transmitted using the dedicated orthogonal code allocated to the mobile subscriber station after transiting to the sleep mode; and
processing the signal based on a decision that the signal is a signal mapped to the dedicated orthogonal code for the mobile subscriber station.

12. The method as claimed in claim 11, wherein the dedicated orthogonal code is a dedicated PN (Psuedo-random Noise) code allocated to be exclusively used by the mobile subscriber station.

13. The method as claimed in claim 11, wherein, in the awake mode, in addition to the dedicated orthogonal code the base station transmits information about an available time period during which the dedicated orthogonal code can be used.

14. The method as claimed in claim 13, wherein, when the available time period for the dedicated orthogonal code has expired, the mobile subscriber station transmits the signal through a contention-based access scheme.

15. The method as claimed in claim 11, wherein the dedicated orthogonal code is contained in and carried by a sleep request message transmitted by the base station.

16. The method as claimed in claim 11, wherein the dedicated orthogonal code is contained in and carried by a sleep response message transmitted by the base station in response to a sleep request message transmitted by the mobile subscriber station.

17. The method as claimed in claim 11, wherein the signal received from the subscriber station in the sleep mode is a traffic indication message.

18. The method as claimed in claim 11, wherein the signal received from the mobile subscriber station in the sleep mode is a traffic confirmation message transmitted in response to a traffic indication message transmitted by the base station.

19. The method as claimed in claim 11, wherein the signal received from the mobile subscriber station in the sleep mode is a bandwidth request message.

20. The method as claimed in claim 11, wherein the signal transmitted to the base station using the dedicated orthogonal code is a contention-free access message.

21. A method for mode transition into a sleep mode according to a request of a mobile subscriber station in a broadband wireless access communication system including a base station and at least one mobile subscriber station, between which data to be transmitted exists in an awake mode and no data to be transmitted exists in the sleep mode, the method comprising the steps of:
constructing a sleep request message when the mobile subscriber station needs to transit into the sleep mode;
simultaneously transmitting the constructed sleep request message to the base station and operating a timer for waiting reception of a sleep response message from the base station; and
confirming dedicated orthogonal code information contained in the sleep response message and transiting from the awake mode to the sleep mode when the sleep response message is received from the base station while the timer operates.

22. The method as claimed in claim 21, wherein the dedicated orthogonal code information includes a PN (Psuedo-random Noise) code allocated to the mobile subscriber station and lifetime information of the PN code.

23. The method as claimed in claim 21, wherein the dedicated orthogonal code is a dedicated PN (Psuedo-random Noise) code allocated to be used exclusively by the mobile subscriber station.

24. The method as claimed in claim 21, wherein the mobile subscriber station is assigned the dedicated PN (Psuedo-random Noise) code from the base station, so that the mobile subscriber station can exclusively use the dedicated PN code for a predetermined time period in the sleep mode and can perform fast transition from the sleep mode to the awake mode by means of the PN code.

25. A method for mode transition into a sleep mode according to a request of a base station in a broadband wireless access communication system including a base station and at least one mobile subscriber station, between which data to be transmitted exists in an awake mode and no data to be transmitted exists in the sleep mode, the method comprising the steps of:
constructing a sleep request message when the base station needs to transit into the sleep mode;
simultaneously transmitting the constructed sleep request message to the mobile subscriber station and operating a timer for waiting reception of a sleep response message in response to the sleep request message of the base station;
transiting from the awake mode to the sleep mode when the sleep response message is received from the mobile subscriber station while the timer operates; and
operating a timer for a dedicated orthogonal code allocated to the mobile subscriber station after transiting into the sleep mode.

26. The method as claimed in claim 25, wherein the dedicated orthogonal code is a dedicated PN (Psuedo-random Noise) code allocated to be exclusively used by the mobile subscriber station.

27. The method as claimed in claim 25, wherein the sleep request message includes sleep mode start time information allocated by the base station, dedicated PN code information allocated to the mobile subscriber station, and lifetime information of the dedicated PN (Psuedo-random Noise) code.

28. The method as claimed in claim 25, wherein the sleep request message includes a start time value representing a point in time at which the mobile subscriber station must transit into the sleep mode.

29. The method as claimed in claim 25, wherein the base station allocates a dedicated PN (Psuedo-random Noise) code to the mobile subscriber station, so that the mobile subscriber station can exclusively use the dedicated PN code for a predetermined time period in the sleep mode and can rapidly transit back to the awake mode by means of the PN code after the mobile subscriber station transited from the awake mode to the sleep mode.

30. The method as claimed in claim 29, wherein the base station operates a timer for checking lifetime of the dedicated PN code from a point in time at which the mobile subscriber station transits into the sleep mode.

31. A method for mode transition into an awake mode according to a request of a mobile subscriber station in a broadband wireless access communication system including a base station and at least one mobile subscriber station, between which data to be transmitted exists in the awake mode and no data to be transmitted exists in a sleep mode, the method comprising the steps of:
the mobile subscriber station constructing a mobile subscriber station traffic indication message when the mobile subscriber station needs to transit into the awake mode due to detection of generation of packet data to be transmitted;
simultaneously transmitting the mobile subscriber station traffic indication message and operating a timer when the mobile subscriber station can achieve fast access according to a contention-free scheme after constructing the mobile subscriber station traffic indication message;
transiting from the sleep mode to the awake mode and starting transmission of the packet data when the subscriber station traffic indication message is received while the timer operates.

32. The method as claimed in claim 31, further including a step of determining whether the mobile subscriber station can achieve fast access according to the contention-free scheme, wherein determination is based on whether operation of the timer for the dedicated PN code stored in the mobile subscriber station has been completed.

33. A method for mode transition into an awake mode according to a request of a base station in a broadband wireless access communication system including a base station and at least one mobile subscriber station, between which data to be transmitted exists in the awake mode and data to be transmitted does not exist in a sleep mode, the method comprising the steps of:
constructing a base station traffic indication message when the base station needs to transit into the awake mode due to detection of generation of packet data to be transmitted;
simultaneously broadcasting the base station traffic indication message and operating a timer for waiting for reception of a traffic confirmation message, after constructing the base station traffic indication message;
transiting from the sleep mode to the awake mode and starting transmission of the packet data when the traffic confirmation message is received while the timer operates.

34. The method as claimed in claim 33, wherein the base station traffic indication message includes a connection ID of the mobile subscriber station.

35. The method as claimed in claim 33, wherein the base station traffic indication message includes sleep mode start time information allocated by the base station, dedicated PN (Psuedo-random Noise) code information allocated to the mobile subscriber station, and lifetime information of the dedicated PN code.

36. The method as claimed in claim 33, wherein the traffic confirmation message includes a mobile subscriber station traffic confirmation message.
